(19) United States
(12) Patent Application Publication
(10) Pub. No.: US 2023/0158754 A1
(43) Pub. Date: May 25, 2023

(54) THREADLIKE ADHESIVE STICKING APPARATUS AND METHOD FOR STICKING THREADLIKE ADHESIVE

(71) Applicant: NITTO DENKO CORPORATION, Ibaraki-shi, Osaka (JP)

(72) Inventors: Atsushi TAKASHIMA, Ibaraki-shi, Osaka (JP); Tomohiro TARUNO, Ibaraki-shi, Osaka (JP); Hiromitsu MORISHITA, Ibaraki-shi, Osaka (JP)

(21) Appl. No.: 17/914,567

(22) PCT Filed: Mar. 26, 2021
(86) PCT No.: PCT/JP2021/013146

§ 371 Date: Sep. 26, 2022

(30) Foreign Application Priority Data
Mar. 31, 2020 (JP) 2020-064050

(51) Int. Cl. B29C 65/50; B29C 65/52; B65H 37/02; C09J 7/38; C09J 7/40

(52) U.S. Cl. CPC B29C 65/5035; B29C 65/524; B65H 37/02; C09J 7/385; C09J 7/405; B65H 2301/4127; C09J 2433/00; C09J 2423/045; C09J 2475/005; C09J 2421/005; C09J 2467/005

(57) ABSTRACT

A threadlike adhesive sticking apparatus of the present invention is a threadlike adhesive sticking apparatus configured to press a threadlike adhesive wound in a roll shape together with a release liner against an object while feeding out the threadlike adhesive, and includes a pressing unit configured to press the threadlike adhesive debonded from the release liner against the object. A compression elastic modulus of the release liner is 1.5 MPa or less.

### TECHNICAL FIELD

The present invention relates to a threadlike adhesive sticking apparatus and a method for sticking a threadlike adhesive.

### BACKGROUND ART

An adhesive body such as an adhesive sheet and an adhesive tape is used for bonding of various adherends such as metal, glass, wood, paper, cardboard, and plastic material. For example, for a wound form such as a roll-shaped adhesive tape, a base material having a rear surface subjected to a debonding treatment, which is brought into contact with an adhesive surface, is used to facilitate rewinding.

One of adhesive tape sticking apparatuses is an apparatus in which an adhesive tape pulled out from a tip end of a holder for storing a roll-shaped adhesive tape is pressed against an adherend by a roller provided at the tip end of the holder or a peripheral wall surrounding a hole at the tip end of the holder (see Patent Literatures 1 to 3). In this sticking apparatus, the holder is moved with the roller or the peripheral wall at the tip end brought into contact with the adherend, so that the adhesive tape is stuck to the adherend while the adhesive tape is pulled out.

In addition, one of adhesive tape sticking apparatuses is an apparatus in which a tape-shaped member with an adhesive tape bonding to a release tape is guided by a reel-shaped member and supplied onto a substrate, then the tape-shaped member is pressed and stuck by a pressure head, and the debonded release tape is discharged (see Patent Literature 4). Further, a storage case for a threadlike adhesive member (threadlike adhesive) obtained by applying an adhesive to a threadlike core material (see Patent Literature 5).

### CITATION LIST

### Patent Literature

Patent Literature 1: JP S60-44463 A
Patent Literature 2: JP 2016-74538 A
Patent Literature 3: JP H3-119083 A
Patent Literature 4: Japanese Patent No. 6577915
Patent Literature 5: JP H3-231980 A

### SUMMARY OF INVENTION

### Technical Problem

However, in the above apparatuses, when a threadlike adhesive wound around a reel without a release liner is used instead of the adhesive tape, the threadlike adhesive cannot be successfully fed out and cannot be stuck to an adherend in the apparatuses described in Patent Literatures 1 to 4, as the threadlike adhesive wound without a release liner has a strong self-adhesive force. In addition, when the release liner for the adhesive tape described in Patent Literatures 1 to 4 is used for the threadlike adhesive, the threadlike adhesive is pressed by a planar release liner, and the shape of the threadlike adhesive is deformed. This may decrease a sticking accuracy of the threadlike adhesive due to protrusion from a prescribed sticking path or due to failure to meet a prescribed width of a sticking width of the threadlike adhesive. In addition, the threadlike adhesive may roll on the planar release liner and fall off from the release liner.

In addition, an operator who uses the storage case described in Patent Literature 5 holds the storage case with one hand, pulls out the threadlike adhesive member in a desired length with an end of the threadlike adhesive member held with the other hand, and then presses both ends of the pulled out threadlike adhesive member against an adhesive surface while pulling the both ends to stick the threadlike adhesive member. That is, in Patent Literature 5, it is not assumed that the operator sticks the threadlike adhesive to a desired path while holding and moving the storage case. When the threadlike adhesive is stuck with the storage case held and moved, problems such as debonding, cutting, re-sticking and entanglement of the threadlike adhesive member may occur due to the strength of the self-adhesion force between the threadlike adhesive members wound around the reel. However, in Patent Literature 5, one of the features is that the threadlike adhesive member is wound around the reel without use of a release paper, and it is not assumed that a release liner is used for the threadlike adhesive member.

The present invention has been made in view of the above circumstances, and an object of the present invention is to provide a threadlike adhesive sticking apparatus and a method for sticking a threadlike adhesive that allows for inhibiting or preventing collapse and falling of a threadlike adhesive in a release liner-attached threadlike adhesive and for achieving a smoothly sticking of the threadlike adhesive without lowering sticking accuracy.

### Solution to Problem

A threadlike adhesive sticking apparatus of the present invention is a threadlike adhesive sticking apparatus configured to press a threadlike adhesive wound in a roll shape together with a release liner against an object while the threadlike adhesive is fed out. The threadlike adhesive sticking apparatus includes a pressing unit configured to press the threadlike adhesive debonded from the release liner against the object, and a compression elastic modulus of the release liner is 1.5 MPa or less.

In the threadlike adhesive sticking apparatus of the present invention, for example, the release liner has a slit, and at least a part of the threadlike adhesive is disposed in the slit.

A threadlike adhesive sticking apparatus of the present invention is a threadlike adhesive sticking apparatus configured to press a threadlike adhesive wound in a roll shape together with a release liner against an object while the threadlike adhesive is fed out. The threadlike adhesive sticking apparatus includes a pressing unit configured to press the threadlike adhesive debonded from the release liner against the object. The release liner has a slit, and at least a part of the threadlike adhesive is disposed in the slit.

In the threadlike adhesive sticking apparatus of the present invention, for example, the slit is formed along a path in which the threadlike adhesive is disposed on the release liner.

In the threadlike adhesive sticking apparatus of the present invention, for example, the threadlike adhesive is traverse-wound around a reel over a width of a predetermined length via the release liner, and the release liner is a sheet having a size having at least the predetermined width and a length of at least an outer circumference of the reel.

The threadlike adhesive sticking apparatus of the present invention further includes, for example, a nozzle including an inner wall surface defining a cylindrical internal space and including a tip end having a tip end opening at one end of the inner wall surface, and the tip end opening allows the internal space to communicate with the outside. The pressing unit is configured to press the threadlike adhesive allowed to pass through the internal space and is led out to the outside from the tip end opening, against the object, and portions of a peripheral portion surrounding the tip end opening at the tip end function as the pressing unit.

The threadlike adhesive sticking apparatus of the present invention further includes, for example, an assist mechanism configured to apply an external force in a feeding direction to the threadlike adhesive wound together with the release liner. The pressing unit is configured to press the fed out threadlike adhesive debonded from the release liner against the object.

The threadlike adhesive sticking apparatus of the present invention further includes, for example, a displacement unit attached to the pressing unit and configured to displace the pressing unit by being displaced in a pressing direction; and an absorption mechanism configured to absorb a displacement of the pressing unit with respect to a displacement of the displacement unit in the pressing direction.

A method for sticking a threadlike adhesive of the present invention includes sticking the threadlike adhesive to the object by using the threadlike adhesive sticking apparatus of the present invention.

### Advantageous Effects of Invention

The present invention allows for inhibiting or preventing collapse and falling off of the release liner-attached threadlike adhesive, and allows for a smoothly sticking of the release liner-attached threadlike adhesive without lowering sticking accuracy.

### BRIEF DESCRIPTION OF DRAWINGS

FIG. 1 is a view conceptually illustrating a configuration of a threadlike adhesive sticking apparatus according to a first embodiment of the present invention.

FIG. 2 is a view (1) illustrating a specific example of a conveyance path of a threadlike adhesive in the threadlike adhesive sticking apparatus of the first embodiment.

FIG. 3 is a view (2) illustrating a specific example of the conveyance path of the threadlike adhesive in the threadlike adhesive sticking apparatus of the first embodiment.

FIG. 4 is a view (3) illustrating a specific example of the conveyance path of the threadlike adhesive in the threadlike adhesive sticking apparatus of the first embodiment.

FIG. 5 is a view (4) illustrating a specific example of the conveyance path of the threadlike adhesive in the threadlike adhesive sticking apparatus of the first embodiment.

FIG. 6 is a view illustrating a periphery of a nozzle in the threadlike adhesive sticking apparatus of the first embodiment.

FIG. 7 is a view illustrating a cut surface of the nozzle.

FIG. 8 is a view illustrating a periphery of the nozzle when the threadlike adhesive is cut.

FIG. 9 is a view illustrating a method of measuring a dynamic friction force between a tip end portion of the nozzle and an adhesive surface of the threadlike adhesive.

The parts (a) and (b) of FIG. 10 are enlarged cross-sectional views of a nozzle tip end.

FIG. 11 is a conceptual diagram illustrating a configuration in which the nozzle of the threadlike adhesive sticking apparatus is moved.

FIG. 12 is a view illustrating a first example of a feeding-out assist mechanism.

FIG. 13 is a view illustrating a second example of the feeding-out assist mechanism.

FIG. 14 is a view illustrating a third example of the feeding-out assist mechanism.

FIG. 15 is a view illustrating a fourth example of the feeding-out assist mechanism.

FIG. 16 is a view illustrating a fifth example of the feeding-out assist mechanism.

FIG. 17 is a view illustrating a sixth example of the feeding-out assist mechanism.

FIG. 18 is a perspective view illustrating a threadlike adhesive sticking apparatus according to a second embodiment of the present invention.

The parts (a) and (b) of FIG. 19 are views illustrating an example of a cross-sectional shape of a tip end portion viewed from a tip end opening side. The part (a) of FIG. 19 is a view illustrating a tip end portion having a circular cross-section, and the part (b) of FIG. 19 is a view illustrating a tip end portion having a rectangular cross-section.

FIG. 20 is a perspective view illustrating an internal structure of a threadlike adhesive sticking apparatus according to a third embodiment.

FIG. 21 is a schematic front view illustrating a main part of a threadlike adhesive sticking apparatus according to a fourth embodiment.

The parts (a) and (b) of FIG. 22 are diagrams illustrating a problem of sticking start point creation when an extra length of a threadlike adhesive is short.

The parts (a) and (b) of FIG. 23 are diagrams illustrating a movement of a nozzle in the sticking start point creation when the extra length of a threadlike adhesive is short.

FIG. 24 is a perspective view illustrating a threadlike adhesive sticking apparatus according to a fifth embodiment.

FIG. 25 is a front view illustrating a state where an opening/closing frame is opened in the threadlike adhesive sticking apparatus according to the fifth embodiment.

FIG. 26 is a view illustrating a state where a threadlike adhesive is cut at the end of a sticking operation using the threadlike adhesive sticking apparatus according to the fifth embodiment.

FIG. 27 is a schematic view illustrating a threadlike adhesive sticking apparatus according to a sixth embodiment.

FIG. 28 is a schematic view illustrating a threadlike adhesive used in the threadlike adhesive sticking apparatus.

FIG. 29 is a diagram illustrating a specific example of a winding method of a release liner-attached threadlike adhesive.

FIG. 30 is a diagram illustrating another specific example of the winding method of the release liner-attached threadlike adhesive.

The part (a) of FIG. 31 is a schematic view illustrating a state where a release liner-attached threadlike adhesive according to a configuration example of a seventh embodiment is wound in a roll shape (roll-shaped release liner-attached threadlike adhesive), and the part (b) of FIG. 31 is a cross-sectional view illustrating a cross-section perpendicular to a winding direction of the roll-shaped release liner-attached threadlike adhesive according to the configuration example.

FIG. 32 is a perspective view illustrating a state where the release liner-attached threadlike adhesive according to the configuration example of the seventh embodiment of the present invention is wound around a reel.

The part (a) of FIG. 33 is a cross-sectional view illustrating a cross-section perpendicular to a longitudinal direction of a release liner in the configuration example of the seventh embodiment of the present invention, and the part (b) of FIG. 33 is a cross-sectional view illustrating a cross-section perpendicular to the winding direction of the roll-shaped release liner-attached threadlike adhesive according to the configuration example.

The part (a) of FIG. 34 is a cross-sectional view illustrating a cross-section perpendicular to a longitudinal direction of a release liner-attached threadlike adhesive in a configuration example of an eighth embodiment of the present invention, and the part (b) of FIG. 34 is a cross-sectional view illustrating a cross-section perpendicular to a winding direction of the roll-shaped release liner-attached threadlike adhesive according to the configuration example.

The part (a) of FIG. 35 is a cross-sectional view illustrating a cross-section perpendicular to a longitudinal direction of a release liner-attached adhesive body in the configuration example of the eighth embodiment of the present invention, and the part (b) of FIG. 35 is a cross-sectional view illustrating a cross-section perpendicular to a winding direction of a roll-shaped release liner-attached adhesive body according to the configuration example.

### DESCRIPTION OF EMBODIMENTS

Hereinafter, threadlike adhesive sticking apparatuses according to preferred embodiments of the present invention will be described in detail with reference to the drawings.

### First Embodiment

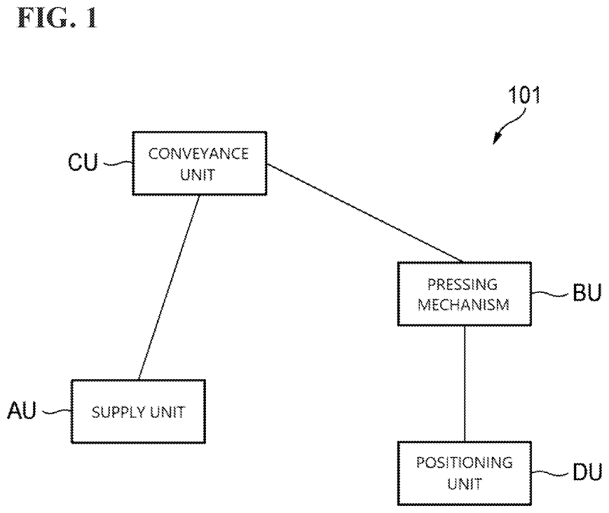

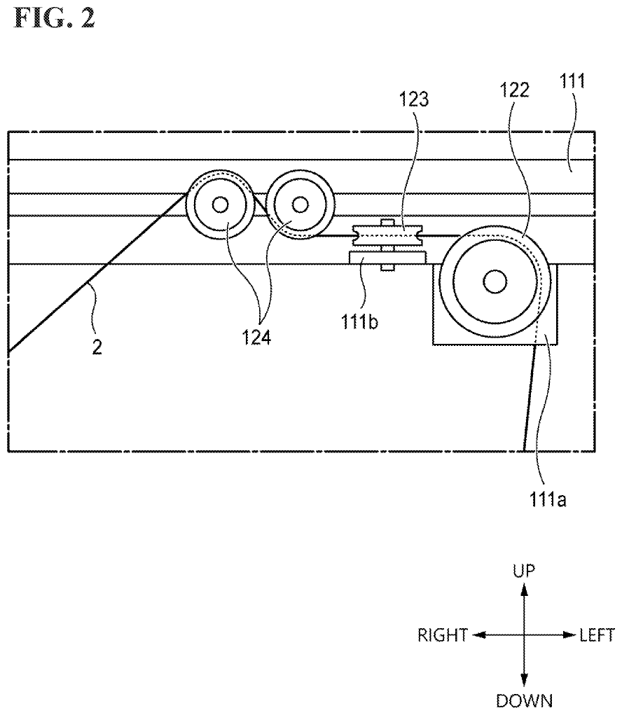

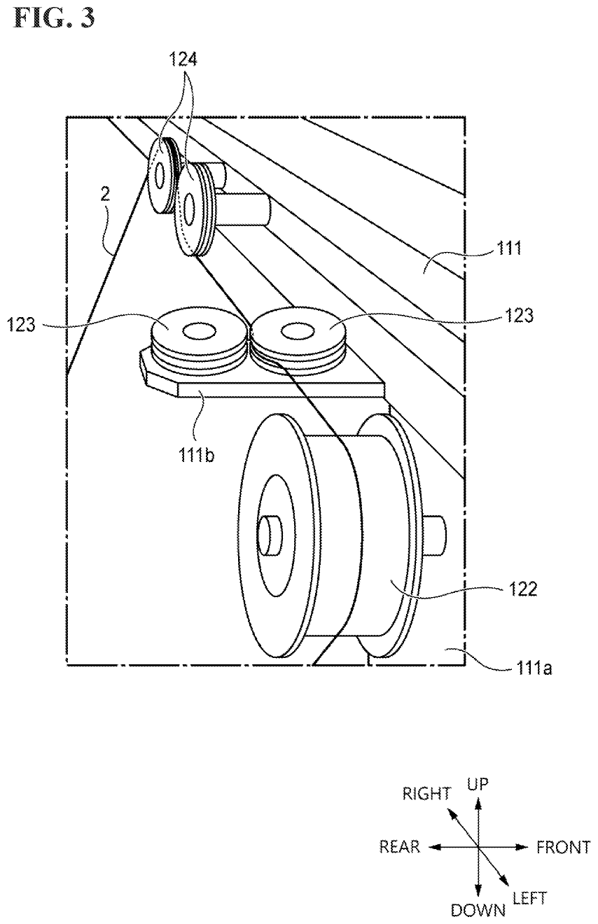

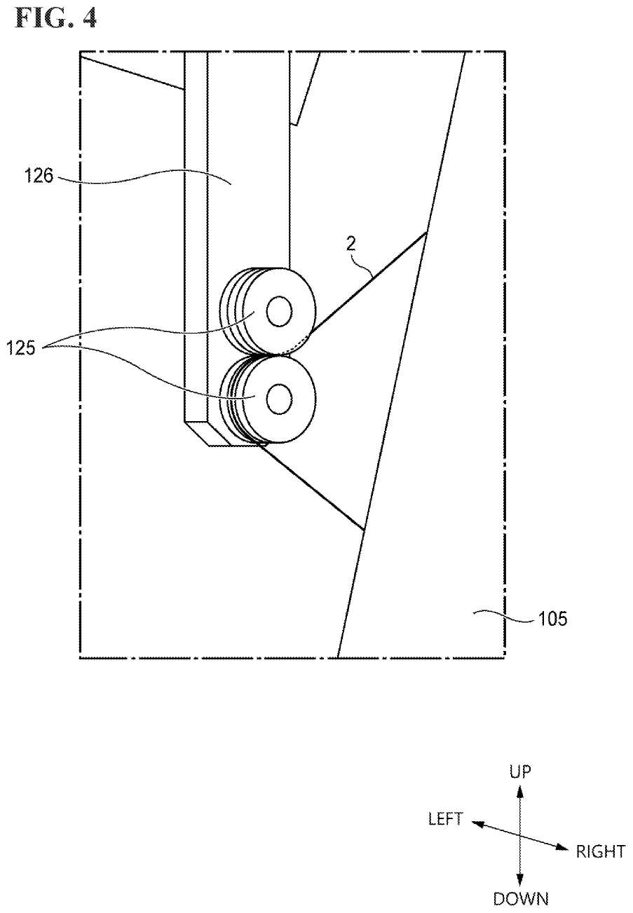

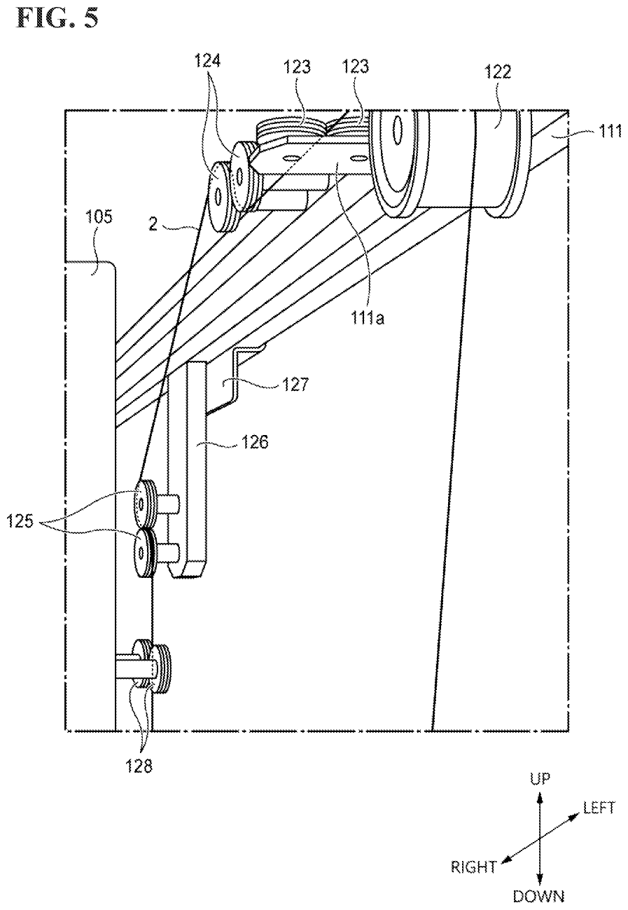

FIG. 1 is a view conceptually illustrating a configuration of a threadlike adhesive sticking apparatus according to a first embodiment of the present invention. FIGS. 2 to 5 are views illustrating specific examples of a conveyance path of a threadlike adhesive in the threadlike adhesive sticking apparatus according to the first embodiment. FIG. 2 and FIG. 4 are views illustrating the threadlike adhesive sticking apparatus as viewed from a rear side. FIG. 3 and FIG. 5 are views illustrating the threadlike adhesive sticking apparatus as viewed from a left side. Arrows shown in FIG. 2 to FIG. 8 indicate front-rear, left-right, and up-down directions of the threadlike adhesive sticking apparatus. The front-rear direction is also referred to as an X-axis direction, the left-right direction (width direction) is also referred to as a Y-axis direction, and the up-down direction (height direction) is also referred to as a Z-axis direction.

A threadlike adhesive sticking apparatus 101 is an apparatus configured to press and stick a threadlike adhesive 2 to an object (adherend). The threadlike adhesive sticking apparatus 101 mainly includes a supply unit AU, a pressing mechanism BU (nozzle), a conveyance unit CU, and a positioning unit DU as shown in FIG. 1. The supply unit AU supplies the threadlike adhesive 2 wound in a roll shape. The pressing mechanism BU is configured to press the supplied threadlike adhesive 2 against the adherend. The conveyance unit CU configured to convey the threadlike adhesive 2 from the supply unit AU to the pressing mechanism BU. The positioning unit DU is configured to position the pressing mechanism BU relative to the object.

### (Positioning Unit DU)

The threadlike adhesive sticking apparatus 101 includes a table disposed on a base and a stage that is slidable on the table along the X-axis direction (front-rear direction), as a part constituting an example of the positioning unit DU. The object is placed on an upper surface of the stage and mounted by suction or the like. When the stage is moved in the X-axis direction by a driving unit, the object is moved in the X-axis direction. In addition, the threadlike adhesive sticking apparatus 101 includes, for example, a pair of support columns erected on left and right sides of the table, and a horizontal arm installed between the pair of support columns along the Y-axis direction (left-right direction) above the pair of support columns.

A horizontal moving unit 105 (see FIG. 5) that is slidable along the Y-axis direction is attached to the horizontal arm. The horizontal moving unit 105 is moved in the Y-axis direction by a driving unit (not shown). The horizontal moving unit 105 has a substantially rectangular parallelepiped shape, and a lifting body (not shown) provided below is slidably held in the Z-axis direction (up-down direction). A nozzle 107 is attached to the lifting body via an attachment plate 106. That is, in the horizontal moving unit 105, the nozzle 107 is configured to move in the Z-axis direction by a driving unit (not shown). Details of the nozzle 107 will be described later.

In the threadlike adhesive sticking apparatus 101, the nozzle 107 can be positioned relative to the object in an XY plane by the stage and the horizontal moving unit 105, and the nozzle 107 can be moved in the Z-axis direction by raising and lowering the lifting body of the horizontal moving unit 105. That is, the stage and the horizontal moving unit 105 function as the positioning unit DU.

### (Supply Unit AU)

The threadlike adhesive sticking apparatus 101 includes a winding body and a winding body holding unit as an example of the supply unit AU. The winding body has a cylindrical shape such as a reel, a paper tube, and a bobbin. The threadlike adhesive 2 obtained by applying an adhesive to a threadlike core material is wound around an outer peripheral surface of the winding body. The winding body can be formed of a metal, a resin, an easily debondable material, or the like. The winding body holding unit is configured to hold the winding body such that movement of the winding body in the front-rear direction is restricted in the vicinity of both ends of the winding body around which the threadlike adhesive 2 is wound, and the winding body is rotatable as the threadlike adhesive 2 is conveyed (fed out). The threadlike adhesive 2 is an adhesive body obtained by covering a surface of a threadlike core material with an adhesive layer. Details of the threadlike adhesive 2 will be described later.

The threadlike adhesive sticking apparatus 101 can supply the threadlike adhesive 2 wound in a roll shape by the winding body and the winding body holding unit. That is, the winding body and the winding body holding unit function as the supply unit AU.

### (Conveyance Unit CU)

The threadlike adhesive sticking apparatus 101 includes a roller 122 and each pair of rollers 123, 124, 125, and 128 as an example of the conveyance unit CU, and is configured to convey the threadlike adhesive 2 fed out from the supply unit AU (winding body) to the nozzle 107. In the roller 122 and each pair of rollers 123, 124, 125, and 128, at least the outer peripheral surface (rotating surface) in contact with the threadlike adhesive 2 is a non-adhesive surface. That is, at least the outer peripheral surface of each roller in contact with the threadlike adhesive 2 is formed of, for example, at least one of a fluorine resin, a silicone resin, and a polyolefin resin. Alternatively, at least the outer peripheral surface of each roller in contact with the threadlike adhesive 2 is subjected to a non-adhesive treatment by, for example, at least one of fluorine coating, silicone coating, long-chain alkyl coating, and Tosical (registered trademark) coating. The treatment of the fluorine coating includes a treatment with a fluorine resin heat-shrinkable tube and a treatment with a fluorine resin fabric sheet. Alternatively, at least the outer peripheral surface of each roller in contact with the threadlike adhesive 2 may be subjected to various non-adhesive treatments on the base material. For example, the base material may be subjected to blasting to have an uneven face, and concave portions may be coated with a non-adhesive substance, or the base material may be treated with PEEK (polyether ether ketone) coating, fluorine composite electroless nickel plating (in which fine particles of a fluorine resin are dispersed and co-deposited in a film of electroless nickel plating), Biceram (fluorine resin coating containing micronized ceramic particles), fiber reinforced plastics (FRP) lining, ultrahigh molecular polyester (PE) lining, or the like.

The roller 122 and each pair of rollers 123 and 124 are attached to a rear side of a frame 111. The frame 111 is installed, along the Y-axis direction, between a pair of frames erected on a left side of the winding body holding unit 121 and a right side of the table on the base.

The roller 122 is rotatably attached to a rectangular attachment portion 111a extending downward in the vicinity of a left end portion of the frame 111, in a perpendicular plane (YZ plane). As shown in FIG. 3, the roller 122 preferably has a bobbin shape having flanges at both ends. When the threadlike adhesive 2 is fed out from the winding body, the threadlike adhesive 2 is moved in a width direction of the body of the roller 122, and the threadlike adhesive 2 is less likely to fall off from the roller 122 due to the flanges at both ends. The pair of rollers 123 is rotatably attached to a rectangular attachment portion 111b extending in the front-rear direction on a right side of the attachment portion 111a on the frame 111, in a horizontal plane (XY plane). On the attachment portion 111b, the pair of rollers 123 is disposed adjacent to the front and rear so as to be separated from each other so that the threadlike adhesive 2 can be allowed to pass therebetween while being guided by the rotating surfaces of the pair of rollers 123 (see FIG. 3). The threadlike adhesive 2, which has been fed upward from the winding body and has been allowed to pass through the rotating surfaces (outer peripheral surfaces) of the roller 122 on the left side and the upper side as shown in FIG. 2, is allowed to pass between the pair of rollers 123 and reaches the pair of rollers 124 as shown in FIG. 3.

The pair of rollers 124 is rotatably attached in the perpendicular plane on the right side of the pair of rollers 123 on the frame 111. The pair of rollers 124 are disposed adjacent to the left and right so as to be separated from each other so that the threadlike adhesive 2 can be allowed to pass therebetween while being guided by the rotating surfaces of the pair of rollers 124 (see FIG. 2 and FIG. 3). As shown in FIG. 3, the threadlike adhesive 2, which has been allowed to pass between the pair of rollers 123, is allowed to pass through the upper rotating surface of the right roller 124 from the lower rotating surface of the left roller 124, and reaches the pair of rollers 125. The pair of rollers 123 and the pair of rollers 124 can prevent meandering of the threadlike adhesive 2 fed out from the winding body, but these are not necessarily required, and the rollers 123 and 124 may not be provided.

The pair of rollers 125 is rotatably attached to a lower side of an oil damper 126 extending substantially in the Z-axis direction, in the perpendicular plane. An upper end portion of the oil damper 126 is rotatably fixed to a damper attachment portion having a substantially rectangular shape, in the perpendicular plane. The damper attachment portion protrudes downward substantially at the center of the frame 111 in the Y-axis direction. The pair of rollers 125 is disposed adjacent to each other along an extending direction of the oil damper so as to be separated from each other so that the threadlike adhesive 2 can be allowed to pass therebetween while being guided by the rotating surfaces of the pair of rollers 125 (see FIG. 4). As shown in FIG. 5, the threadlike adhesive 2, which has been allowed to pass between the pair of rollers 124, is allowed to pass through the right and lower rotating surfaces of the upper roller 125, is allowed to pass through the upper and left rotating surfaces of the lower roller 125, and reaches a pair of rollers 128. The threadlike adhesive 2 guided by the pair of rollers 125 is prevented from slackening by a lower part of the oil damper 126 swinging slowly to the left and right. The pair of rollers 125 and the oil damper 126 may not be provided. This is because, changing a location where the winding body is placed or a moving speed of the positioning unit DU prevents occurrence of the slackening of the threadlike adhesive 2 and this eliminates the need for the function of preventing the slackening by the pair of rollers 125 and the oil damper 126.

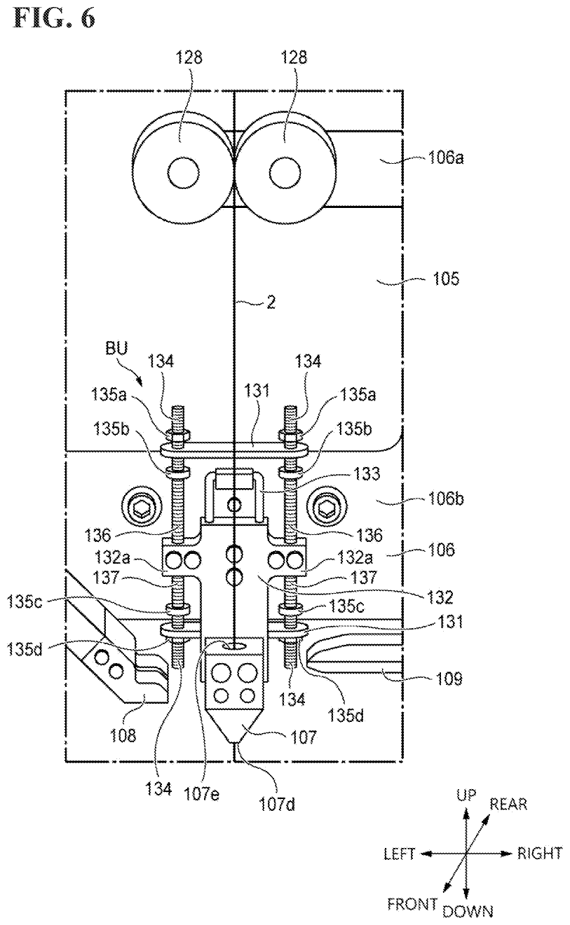

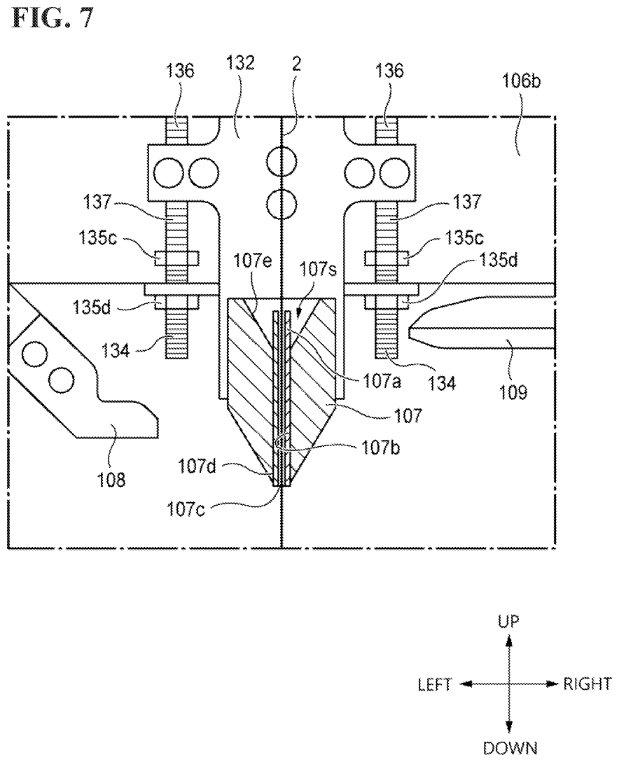

The pair of rollers 128 is rotatably attached to a roller attachment unit 106a of the attachment plate 106 disposed on a front of the horizontal moving unit 105, in the perpendicular plane. The pair of rollers 128 is disposed adjacent to the left and right so as to be separated from each other so that the threadlike adhesive 2 can be allowed to pass therebetween while being guided by the rotating surfaces of the pair of rollers 128. As shown in FIG. 6, the threadlike adhesive 2, which has been allowed to pass between the pair of rollers 125, is allowed to pass between the pair of rollers 128 and reaches the nozzle 107. Since the pair of rollers 128 is provided directly above the nozzle 107 attached to the attachment plate 106, the threadlike adhesive 2 is guided by the pair of rollers 128 and enters straight into a cylindrical internal space 107s (see FIG. 7) of the nozzle 107 regardless of the position of the nozzle 107. The pair of rollers 128 may be disposed adjacent up and down and guide the threadlike adhesive 2 to the position of the nozzle 107 by passing the threadlike adhesive 2 in an S-shape, or may guide the threadlike adhesive 2 to the position of the nozzle 107 by another configuration.

The threadlike adhesive sticking apparatus 101 is configured to convey the threadlike adhesive 2 from the supply unit AU to the pressing mechanism BU by the roller 122 and each pair of rollers 123, 124, 125, and 128. That is, the roller 122 and each pair of rollers 123, 124, 125, and 128 function as the conveyance unit CU. The conveyance unit CU may convey the threadlike adhesive 2 to, for example, a pressing unit configured to press the threadlike adhesive 2 against the adherend with a roller other than the pressing mechanism BU.

### (Pressing Mechanism BU)

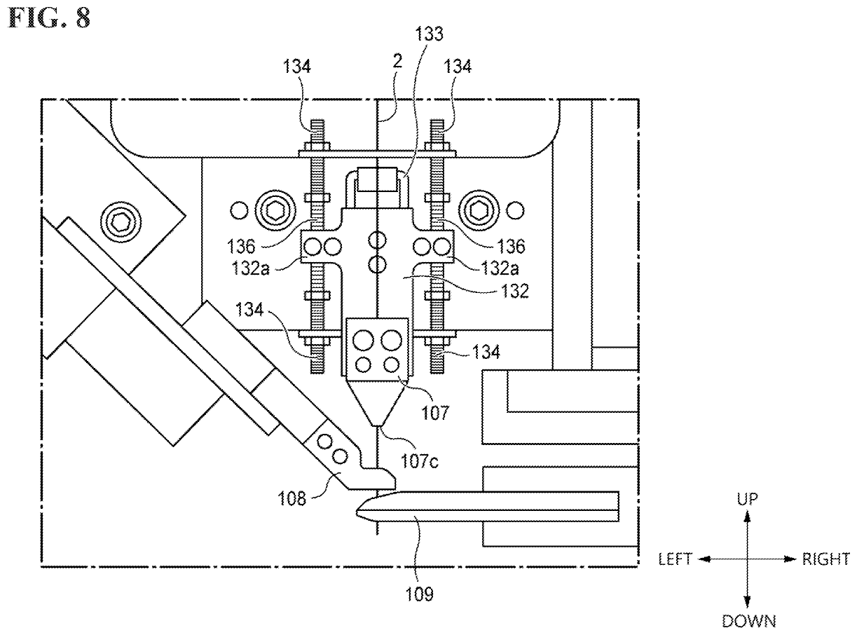

An example of the pressing mechanism BU provided on the threadlike adhesive sticking apparatus 101 will be described with reference to FIGS. 6 to 8. FIGS. 6 to 8 are views illustrating the periphery of the nozzle 107 of the threadlike adhesive sticking apparatus 101. FIG. 6 is a perspective view illustrating the periphery of the nozzle 107 as viewed from a front upper side. FIG. 7 is a view including a cross-section of the nozzle 107 in the YZ plane along the threadlike adhesive 2. FIG. 8 is a view illustrating a state of cutting the threadlike adhesive 2.

The threadlike adhesive sticking apparatus 101 includes the attachment plate 106 and the nozzle 107 as a part constituting an example of the pressing mechanism BU. The attachment plate 106 is slidably attached in the Z-axis direction with respect to the horizontal moving unit 105 on the front side of the horizontal moving unit 105. The attachment plate 106 is a thin metal flat plate formed in a substantially U shape, and includes the roller attachment unit 106a, a nozzle attachment unit 106b (nozzle displacement unit), and a substantially rectangular connection portion elongated in the Z direction. The roller attachment unit 106a is a substantially rectangular portion extending in the Y-axis direction above the connection portion. The pair of rollers 128 are attached to the front side of the roller attachment unit 106a. The nozzle attachment unit 106b is a substantially rectangular portion extending in the Y direction below the connection portion. The nozzle 107, an air chuck 108, and an air scissor 109 are attached to the front side of the nozzle attachment unit 106b.

The nozzle 107 is a member formed of aluminum or the like and having a shape obtained by connecting a bottom surface of a cone to a lower surface of a cube. The nozzle 107 has an inner wall surface 107b that defines the cylindrical internal space 107s extending in the up-down direction, and a tip end 107d having a tip end opening 107c allowing the cylindrical internal space 107s to communicate with the outside at a lower end portion of the inner wall surface 107b. The nozzle 107 is a member formed of metal or the like, and the surface of the nozzle 107 including the inner wall surface 107b and the tip end 107d is subjected to a slidability improving treatment. The nozzle 107 has an insertion-side opening 107e at the upper end portion of the inner wall surface 107b, the insertion-side opening 107e allowing the cylindrical internal space 107s to communicate with the outside. The inner wall surface 107b is formed such that the cylindrical internal space 107s has a funnel shape in which a cylinder having the same diameter as the tip end opening 107c extends upward from the tip end opening 107c and gradually increases in diameter. The insertion-side opening 107e has a funnel shape whose diameter is larger than that of the tip end opening 107c. The inner wall surface 107b may define a cylindrical internal space, and for example, an upper portion of the inner wall surface 107b may be formed as a cylinder or the like having the same diameter instead of a funnel shape.

In the cylindrical internal space 107s of the nozzle 107, a tube 107a formed of a hardly adhesive resin such as polytetrafluoroethylene (PTFE) and having a hollow cylindrical shape from the upper end to below the lower end (tip end 107d) of the nozzle 107 may be provided. Alternatively, a surface treatment for improving slidability may be performed on the cylindrical internal space 107s. In the tube 107a, a diameter of the lower side opening is preferably, for example, about 1 mm, and a diameter of the threadlike adhesive 2 is preferably, for example, 0.45 mm That is, a cross-sectional area of the lower side opening of the tube 107a is preferably about 4.9 times a cross-sectional area of the threadlike adhesive 2. The tube 107a protrudes slightly (for example, about 0.5 to 1 mm) from the lower end of the inner wall surface 107b. Inserting the threadlike adhesive 2 into the tube 107a allows for improving the slidability (feedability) of the threadlike adhesive 2. The insertion-side opening 107e is enlarged in diameter, and thus the threadlike adhesive 2 is easily inserted into the nozzle 107. In addition, when the material of the nozzle 107 itself is a hardly adhesive resin such as PTFE, the threadlike adhesive 2 can be prevent from adhering to the nozzle 107. As a result, the threadlike adhesive 2 can be smoothly fed out from the nozzle 107 without being caught, and thus the tube 107a is unnecessary. Further, a shape of the nozzle 107 is not limited as long as the nozzle 107 has a cylindrical internal space and a tip end having a tip end opening allowing the internal space to communicate with the outside. In addition, in the nozzle 107, a shape of the tip end opening 107c (or a lower side opening of the tube 107a) is preferably a circular shape or a polygonal shape having five or more corners.

The nozzle 107 presses the threadlike adhesive 2, which has been allowed to pass through the tube 107a (cylindrical internal space 107s) and has been led out to the outside from the lower side opening (tip end opening 107c) of the tube 107a, against the object. More specifically, an entire circumference or some positions of the lower end portion of the tube 107a, which is the peripheral portion surrounding the tip end opening 107c of the nozzle 107, function as the pressing unit configured to press the threadlike adhesive 2 against the object. This allows for sticking the threadlike adhesive while moving the nozzle 107 in any directions without using a roller or the like as the pressing unit. Therefore, this prevents a problem in the case of pressing the adhesive by the roller, that the adhesion accuracy is poor due to the movement of the adhesive within a roller width, and the adhesive is detached from the roller depending on an adhesion path. And, such a nozzle allows for accurately sticking the threadlike adhesive.

### (Relationship Between Hole Diameter of Nozzle 107 and Diameter of Threadlike Adhesive 2)

A hole diameter of the nozzle 107 (diameter on an inner side (inner diameter), or a hole diameter of the tube 107a when the tube 107a is provided) is preferably 0.7 mm to 1 mm in diameter when the threadlike adhesive 2 has a diameter of 0.45 mm (a width of 0.6 mm in compression of about 0.3 MPa). When the hole diameter of the nozzle 107 is smaller than 0.7 mm, an area where the threadlike adhesive 2 contacts the inside of the nozzle 107 becomes large, and thus the threadlike adhesive 2 does not stick to the adherend. On the other hand, when the hole diameter of the nozzle 107 exceeds 1 mm and is too large, the threadlike adhesive 2 is moved inside the nozzle 107, and thus a sticking speed does not increase and the sticking accuracy deteriorates. Therefore, a ratio of the diameter of the threadlike adhesive 2 to the hole diameter of the nozzle 107 is preferably 0.45:0.7 to 1.

The nozzle 107 is configured to press the threadlike adhesive 2 against the object while the lower side opening (or the tip end opening 107c) of the tube 107a comes into contact with and slides on the adhesive surface of the threadlike adhesive 2. Specifically, the tip end 107d of the nozzle 107 (or the tip end of the tube 107a, at least a portion in contact with the adhesive surface) may be formed of at least one of a fluorine resin, a silicone resin, and a polyolefin resin. Alternatively, the tip end 107d of the nozzle 107 (or the tip end of the tube 107a, at least a portion in contact with the adhesive surface) is treated by at least one of fluorine coating, silicone coating, and long-chain alkyl coating. Alternatively, various slidability improving treatments described below are performed. The treatment of fluorine coating includes a treatment with a fluorine resin heat-shrinkable tube and a fluorine resin fabric sheet.

The tip end portion of the nozzle 107 may be subjected to various slidability improving treatments on the base material. For example, the base material may be treated with PEEK (polyether ether ketone) coating, fluorine composite electroless nickel plating (in which fine particles of a fluorine resin are dispersed and co-deposited in a film of electroless nickel plating), Biceram (fluorine resin coating containing micronized ceramic particles), fiber reinforced plastics (FRP) lining, ultrahigh molecular polyester (PE) lining, or the like. As a result, the threadlike adhesive 2 can be smoothly stuck to the object.

When the nozzle 107 to be in contact with the adhesive surface of the threadlike adhesive 2 is not hardly adhesive, a dynamic friction force between the tip end 107d coated/treated for improving slidability and the adhesive surface is preferably 3 N/mm or less. When the tube 107a formed of a hardly adhesive resin is inserted into the nozzle 107, a dynamic friction force between the lower side opening of the tube 107a and the adhesive surface of the threadlike adhesive 2 is preferably 3 N/mm or less. When the nozzle 107 itself is formed of a hardly adhesive resin such as PTFE (silicone, olefin, etc.), a dynamic friction force between the tip end opening 107c and the adhesive surface of the threadlike adhesive 2 is preferably 3 N/mm or less.

Depending on a shape and a material/surface treatment of the tip end portion of the nozzle 107 (details will be described later), the tip end portion of the nozzle 107 to be in contact with the adhesive surface of the threadlike adhesive 2 has a low frictional force with respect to the adhesive surface. In addition, the tip end portion of the nozzle 107 is formed of a material with reduced unevenness or is subjected to a surface treatment such that the portion has reduced unevenness, and thus this allows for preventing occurrence of scraping or the like when the soft threadlike adhesive 2 slides thereon. Therefore, the threadlike adhesive 2 can be smoothly stuck. The dynamic friction force between the tip end portion of the nozzle 107 and the adhesive surface of the threadlike adhesive 2 can be measured by the following method.

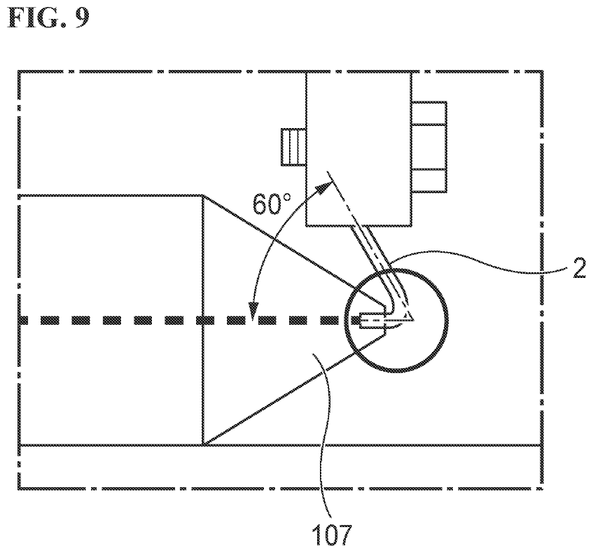

As shown in FIG. 9, the nozzle 107 is placed on a horizontal plane so that the cylindrical internal space 107s extends in the horizontal direction, and the threadlike adhesive 2 inserted from the insertion-side opening 107e is pulled out from the tip end opening 107c. The threadlike adhesive 2 is set so that an angle formed by the threadlike adhesive 2 which has been allowed to pass through the cylindrical internal space 107s and the threadlike adhesive 2 pulled out from the tip end opening 107c is 60 degrees. By setting in this manner, the threadlike adhesive 2 reliably comes into contact with the tip end portion of the nozzle 107. On an insertion-side opening 107e side, tension is applied to the threadlike adhesive 2 with a weight of 10 g. In this state, the threadlike adhesive 2 pulled out from the tip end opening 107c is pulled upward in the vertical direction at 1 mm/sec, and a stress (value at the time of stabilization) is measured. At this time, a width (thickness) of the threadlike adhesive 2 that has pressed against the nozzle tip end indicated by a circle in FIG. 9 is, for example, 0.4 mm A value obtained by dividing a value of a stress when the threadlike adhesive 2 is being moved in this way by the width of the threadlike adhesive 2 is defined as the dynamic friction force.

Since the tip end portion of the nozzle 107 in the present embodiment has a dynamic friction force of 3 N/mm or less with respect to the adhesive surface of the threadlike adhesive 2, the threadlike adhesive 2 can be smoothly stuck. In addition, the dynamic friction force between the tip end portion of the nozzle 107 and the adhesive surface of the threadlike adhesive 2 is preferably 1 N/mm or less. The dynamic friction force between the tip end portion of the nozzle and the adhesive surface of the threadlike adhesive 2 is 3 N/mm or less, even when the width (thickness) of the threadlike adhesive 2 that has pressed against the nozzle tip end is not 0.4 mm, and also when the width (thickness) of the threadlike adhesive 2 that has pressed against the nozzle tip end is 0.2 mm to 0.45 mm or other sizes.

Furthermore, when the shape of the tip end opening 107c (or the lower side opening of the tube 107a) is a circular shape or a polygonal shape having five or more corners, the nozzle 107 can easily change a sticking direction.

The parts (a) and (b) of FIG. 10 are enlarged cross-sectional views of the tip end 107d of the nozzle 107, and show an example of the nozzle 107 having a shape different from that described above. The nozzle 107 may be formed of a hardly adhesive resin such as fluorine resin, or may be a nozzle formed of a metal and whose surface has been subjected to a slidability improving treatment. In the part (a) of FIG. 10, the tip end 107d has a corner, and the threadlike adhesive 2 may be caught, displaced, or cut. In the part (b) of FIG. 10, the tip end 107d is round, that is, the portion pressing the threadlike adhesive 2 is a curved surface, and thus, the threadlike adhesive 2 is not caught and can be favorably stuck. When the nozzle 107 shown in the part (b) of FIG. 10 is formed of a resin such as fluorine resin, the nozzle 107 may be protected by passing the nozzle 107 through a guide formed of stainless steel (SUS).

The nozzle 107 is configured to be movable in the up-down direction and to include an absorption mechanism configured to absorb a displacement of the nozzle 107 with respect to a displacement of a base to which the nozzle 107 is attached in the up-down direction. Hereinafter, an example of this configuration will be described, but the configuration related to the displacement of the nozzle is not limited to the following configuration. The nozzle 107 is fixed to a slider 132 movable in the up-down direction along a slide rail 133. The slider 132 has a substantially rectangular parallelepiped shape and has bulging portions 132a in which portions of the left and right side surfaces of the slider 132 protrudes to the left and right sides of the slider 132, respectively.

The slide rail 133 is attached to the front of the nozzle attachment unit 106b along the up-down direction. Two bolts 134 and springs 136 and 137 disposed between the two bolts 134 are respectively provided on the left and right sides of the slide rail 133 along the up-down direction. The bolts 134 are inserted through the left and right end portions of horizontally long bolt insertion portions 131 in the up-down direction. The bolt insertion portion 131 extends forward from an upper side and a lower side of the nozzle attachment unit 106b, separately. Nuts 135a and 135b are respectively disposed on left and right sides above and below the upper bolt insertion portion 131, and are screwed to the bolts 134. Nuts 135c and 135d are respectively disposed on the left and right sides above and below the lower bolt insertion portion 131, and are screwed to the bolts 134.

The spring 136 is disposed between the nut 135b and the upper portion of the bulging portion 132a, and the spring 137 is disposed between the lower portion of the bulging portion 132a and the nut 135c. A lower end portion of the upper bolt 134 is inserted into an upper side of the spring 136, and a lower side of the spring 136 is fixed to the bulging portion 132a, thereby preventing the spring 136 from being detached. The upper side of the spring 137 is fixed to the bulging portion 132a, and the upper end portion of the lower bolt 134 is inserted into the lower side of the spring 137, thereby preventing the spring 137 from being detached.

The nozzle 107 is fixed to the slider 132, and the nozzle 107 is displaced in accordance with the displacement of the slider 132 in the up-down direction. Specifically, as the lifting body of the horizontal moving unit 105 is raised and lowered (displaced), the nozzle attachment unit 106b fixed to the lifting body is raised and lowered (displaced). Here, the springs 136 and 137 are attached to the upper part and lower part of the slider 132 slidably attached to the nozzle attachment unit 106b. The slider 132 does not slide, and a position of the slider 132 on the nozzle attachment unit 106b does not change in a state where no load is applied to the nozzle 107. On the other hand, when the nozzle 107 is pressed against the object via the threadlike adhesive 2, an elastic force in a direction opposite to the pressing direction is generated in the springs 136 and 137. That is, the springs 136 and 137 absorb the displacement of the nozzle 107 with respect to the displacement of the nozzle attachment unit 106b. As a result, this allows for controlling a force (pressing force) with which the nozzle 107 presses the threadlike adhesive 2 against the object to prevent the pressing force from excessively increasing or rapidly increasing. Therefore, it is possible to prevent a large deformation of the threadlike adhesive 2, that is, a problem such as sticking out of the adhesive (lowering of adhesion width accuracy) or unevenness of the height of the threadlike adhesive 2 due to an excessively strong pressing force, and to achieve the appropriate adhesive force of the threadlike adhesive. In addition, it is possible to protect the apparatus by preventing an excessive load from being applied to the nozzle 107.

In this way, the springs 136 and 137 function as an absorption mechanism configured to absorb the displacement of the nozzle 107 with respect to the displacement of the nozzle attachment unit 106b, and gently change the pressing force. Therefore, even when a height of an adhesive surface of the object changes depending on the accuracy or when the adhesive surface of the object is not smooth and has unevenness, the above-described problem can be prevented. In addition, even in a portion where the threadlike adhesive 2 overlaps in the sticking path, the threadlike adhesive 2 can be smoothly stuck over the stuck threadlike adhesive 2 due to the function of the springs 136 and 137. Instead of the springs 136 and 137, an oil damper or an air cylinder may be attached between the nozzle attachment unit 106b and the nozzle 107 to function as an absorption mechanism. The pressing mechanism BU described above is merely an example. The pressing mechanism BU may have another configuration such that the nozzle 107 is movable in the up-down direction, and includes an absorption mechanism configured to absorb the displacement of the nozzle 107 with respect to the displacement of the base to which the nozzle 107 is attached in the up-down direction.

The air chuck 108 and the air scissor 109 are attached to the nozzle attachment unit 106b on the left and right sides of the nozzle 107, respectively (see FIG. 6 and FIG. 7). When the sticking of the threadlike adhesive 2 is completed, the air chuck 108 and the air scissor 109 are separately moved from a normal position shown in FIG. 6 and FIG. 7 to a position shown in FIG. 8 by a driving unit. The air chuck 108 is moved obliquely from the normal position to the lower right, and chucks the threadlike adhesive 2 directly below the nozzle 107. The air scissor 109 is moved downward from the normal position and then moved leftward to cut the chucked threadlike adhesive 2 directly below the air chuck 108. The air chuck 108 and the air scissor 109 are attached to the lifting body of the horizontal moving unit 105 via the attachment plate 106, like the nozzle 107, and thus, the air chuck 108 and the air scissor 109 can be moved together with the nozzle 107, maintaining the positional relationship with respect to the nozzle 107. The air chuck 108 and the air scissor 109 are not limited in shape, driving method, and the like as long as they can hold and cut the threadlike adhesive 2 at predetermined positions. In addition, instead of the air scissor 109, the threadlike adhesive 2 may be burned off by heat cutting using a heat cutter or the like.

In the threadlike adhesive sticking apparatus 101, the threadlike adhesive 2 supplied from the supply unit AU is pressed against the adherend by the nozzle 107, the springs 136 and 137, the lifting body of the horizontal moving unit 105, and the attachment plate 106. That is, the nozzle 107, the springs 136 and 137, the lifting body of the horizontal moving unit 105, and the attachment plate 106 function as the pressing mechanism BU.

### (Operation of Threadlike Adhesive Sticking Apparatus 101 and Method for Sticking Threadlike Adhesive)

Using the threadlike adhesive sticking apparatus 101 configured as described above, an operator who sticks the threadlike adhesive 2 to an object first places the object on a stage. At the start of the operation, the threadlike adhesive 2 supplied from the winding body to the nozzle 107 is led out to the outside from the tip end 107d of the nozzle 107, and the operator presses the tip end into a predetermined position on the object. A relative position of the nozzle 107 with respect to the object is subjected to movement control by a control apparatus (movement control unit) (not shown) in accordance with a program set in advance. The program includes instructions such as a movement path, a movement speed, and a movement amount (a magnitude of a pressing force) in the Z direction of the nozzle 107 in the XY plane. When the movement of the nozzle 107 is started according to the program, the threadlike adhesive 2 is fed out from the winding body by an adhesive force of the threadlike adhesive 2 with respect to the object. The nozzle 107 presses the adhesive surface of the fed out adhesive surface 2, and the threadlike adhesive 2 is pressed against and stuck (press-bonded) to the object along a predetermined path while the nozzle 107 slides on the adhesive surface. After the sticking is completed, the threadlike adhesive 2 is cut at a predetermined position by the air chuck 108 and the air scissor 109.

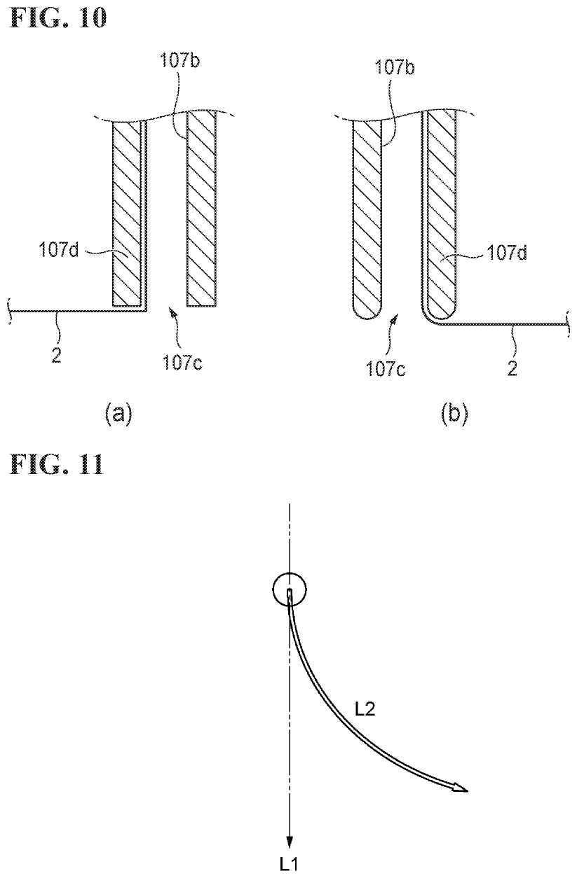

FIG. 11 is a conceptual diagram illustrating a mode in which the nozzle 107 is moved on the object. Not only when the nozzle 107 goes straight as shown by an arrow L1, but also when a curve shown by an arrow L2 is extremely bent (bent at a steep angle), the threadlike adhesive sticking apparatus 101 can stick the threadlike adhesive 2 with high accuracy. In the threadlike adhesive sticking apparatus 101, the entire circumference (any positions in the peripheral portion) surrounding the tip end opening 107c in the tip end 107d of the nozzle 107 functions as a pressing portion configured to press the threadlike adhesive 2 against the object, and thus, the moving direction can be easily changed. Therefore, the threadlike adhesive sticking apparatus 101 can stick the threadlike adhesive 2 along a predetermined sticking path with high accuracy. The threadlike adhesive sticking apparatus 101 does not use a roller or the like as the pressing portion, and thus, this allows for preventing problems such as poor sticking accuracy due to the movement of the adhesive within the width of the roller when the adhesive is pressed by the roller, and detachment of the adhesive from the roller depending on the sticking path.

When the threadlike adhesive 2 is stuck to the object along a predetermined path, the threadlike adhesive sticking apparatus 101 (movement control unit) may press the nozzle 107 more strongly at a desired position, that is, increase a downward displacement amount of the nozzle attachment unit 106b in the Z-axis direction (approach the object). Even when the nozzle attachment unit 106b is momentarily lowered, it is possible to appropriately increase the force with which the nozzle 107 presses the threadlike adhesive 2 and to increase the adhesive force of the threadlike adhesive 2 at a desired position since the nozzle 107 is gently lowered by the springs 136 and 137 (absorption mechanism). In addition, the threadlike adhesive sticking apparatus 101 (movement control unit) may stop the movement in the XY plane (fix the position of the nozzle 107 with respect to the object) with the nozzle 107 maintained for several seconds at the desired position. Stopping a plane position of the nozzle 107 while pressing the nozzle 107 allows for increasing a pressing time of the threadlike adhesive 2 and to increase the adhesive force of the threadlike adhesive 2 at a desired position. When the threadlike adhesive 2 is stuck while being fed out from a winding body 120, the threadlike adhesive 2 is easily debonded at a start point (initial stage of sticking) of a predetermined path, a start point or an end point of a curve included in the predetermined path, a vertex of a corner included in the predetermined path. Therefore, lowering the nozzle 107 or stopping the nozzle 107 for several seconds with the nozzle 107 pressed at these positions allows for increasing the adhesive force of the threadlike adhesive 2 and preventing the debonding.

### (Feeding-Out Assist Mechanism)

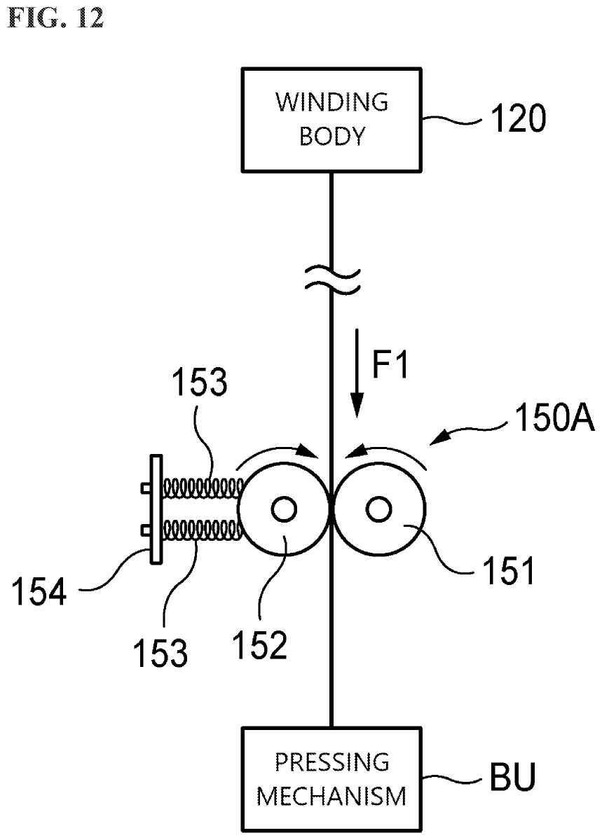

An example of providing the supply unit AU with a feeding-out assist mechanism will be described with reference to FIG. 12 to FIG. 17. The feeding-out assist mechanism is configured to apply an external force in a feeding direction to the threadlike adhesive 2 fed out from the winding body 120. Applying the external force in the feeding direction by the feeding-out assist mechanism allows for smoothly feeding out the threadlike adhesive 2 from the winding body 120 against a self-adhesion force between the threadlike adhesives 2 wound around the winding body 120 even when the threadlike adhesive does not have a release liner. Therefore, the threadlike adhesive 2 can be pressed against the object in a state where the tension of the threadlike adhesive 2 is reduced. Therefore, it is possible to prevent a problem that the threadlike adhesive 2 pressed against the object is debonded, cut, re-stuck, and entangled by tension, and to smoothly stick the threadlike adhesive 2.

Feeding-out assist mechanisms 150A, 150B, 150Ba, and 150C shown in FIG. 12 to FIG. 15 are provided in a path for conveying the threadlike adhesive 2 from the winding body 120 to the pressing mechanism BU, and the feeding-out assist mechanisms apply, to the threadlike adhesive 2, tensile forces (arrows F1 to F3) for pulling the threadlike adhesive 2 sandwiched therebetween in the feeding direction.

The feeding-out assist mechanism 150A shown in FIG. 12 includes a roller 151 (first roller), a roller 152 (second roller), a spring 153 (elastic body), and a spring attachment portion 154. The roller 151 is a feed out roller that is driven and rotated by a motor (not shown). The roller 152 sandwiches the threadlike adhesive 2 with the roller 151, is rotated in conjunction with the rotation of the roller 151, and sandwiches and pulls out the threadlike adhesive 2 in a direction of an arrow F1 (rotation direction). The spring 153 is attached between the roller 151 and the spring attachment portion 154, and the spring attachment portion 154 is fixed in the apparatus. The spring 153 can adjust the tensile force of the rollers 151 and 152. Further, controlling the rotation of the roller 151 allows for feeding out the threadlike adhesive 2 in accordance with a sticking distance (moving distance of the nozzle 107). The rollers 151 and 152 may be configured to be movable in the left-right direction (direction intersecting the direction of the arrow F1) without providing the spring 153.

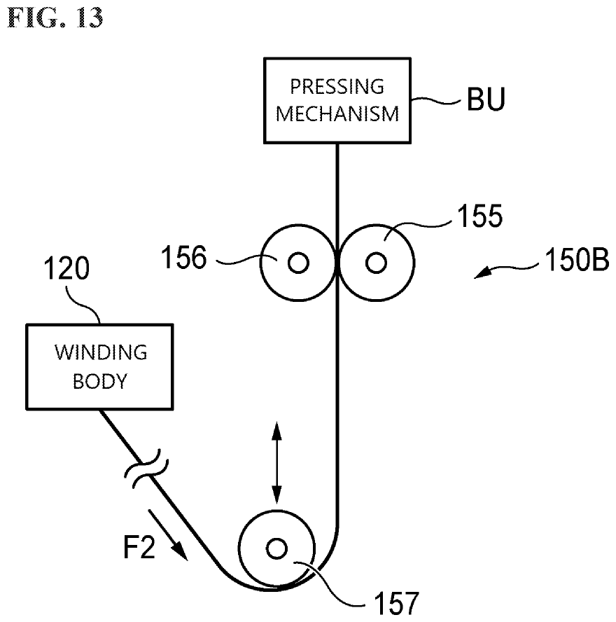

The feeding-out assist mechanism 150B shown in FIG. 13 has a roller 155 (third roller), a roller 156 (fourth roller), and a roller 157 (fifth roller). The rollers 155 and 156 can chuck and release the threadlike adhesive 2 therebetween. The roller 157 is disposed between the winding body 120 and the rollers 155 and 156, and is displaceable so as to lengthen a path from the winding body 120 to the rollers 155 and 156 via the roller 157. When the roller 157 is displaced so as to lengthen this path, the threadlike adhesive 2 is pulled and fed out from the winding body 120 in a direction of an arrow F2. The fed out threadlike adhesive 2 is chucked by the rollers 155 and 156 and supplied to the pressing mechanism BU (nozzle 107). Then, when the chuck by the rollers 155 and 156 is released, the pressing mechanism BU presses the threadlike adhesive 2 against the object. While the chuck by the rollers 155 and 156 is released, the roller 157 returns to an original position. Controlling the displacement of the roller 157 allows for feeding out the threadlike adhesive 2 in accordance with the sticking distance (moving distance of the nozzle 107). In addition, when the threadlike adhesive 2 lacks during the sticking of the threadlike adhesive 2, the threadlike adhesive 2 can be chucked again by the rollers 155 and 156, and the roller 157 can be displaced to feed out the threadlike adhesive 2.

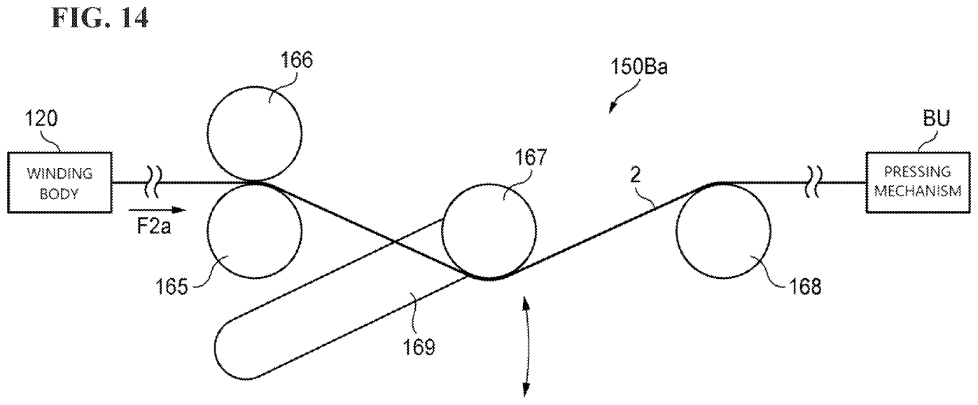

The feeding-out assist mechanism 150Ba shown in FIG. 14 has rollers 165, 166, 167, 168 and an arm 169. The roller 165 is a feed out roller that is driven and rotated by a motor (not shown). The roller 166 sandwiches the threadlike adhesive 2 with the roller 165, is rotated in conjunction with the rotation of the roller 165, and sandwiches and pulls out the threadlike adhesive 2 in a direction of an arrow F2a. The rollers 167 and 168 are provided between the rollers 165 and 166 and the pressing mechanism BU, and guide the threadlike adhesive 2 pulled out by the rollers 165 and 166 to the pressing mechanism BU. The arm 169 has one end to which the roller 167 is attached and the other end that is pivotally supported by a housing of the threadlike adhesive sticking apparatus 101 and to which a potentiometer for calculating the position of the roller 167 is attached. When the roller 167 is moved downward from a position shown in FIG. 14 (is displaced so as to lengthen a path from the rollers 165 and 166 to the roller 168), a conveying speed of the threadlike adhesive 2 decreases. In this way, the threadlike adhesive 2 is fed out by the rollers 165 and 166, and a rapid speed change of the fed out threadlike adhesive 2 can be alleviated by the displacement of the roller 167.

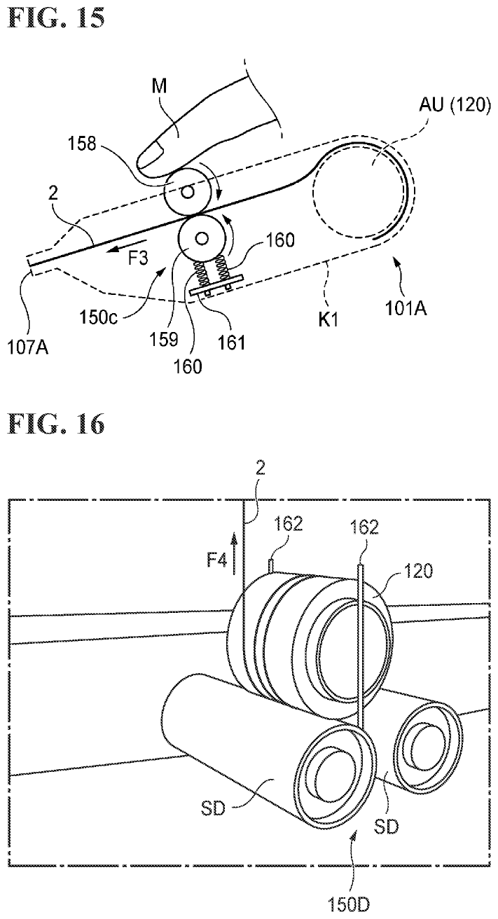

FIG. 15 shows an example in which the feeding-out assist mechanism 150C is provided in a threadlike adhesive sticking apparatus 101A in a mode of being gripped and used by an operator. Members having the same functions as those of the threadlike adhesive sticking apparatus 101 are denoted by the same reference numerals. The threadlike adhesive sticking apparatus 101A includes the supply unit AU (winding body 120) and the feeding-out assist mechanism 150C in a housing K1 having a size and a shape that can be held by one hand of an operator, and has a nozzle 107A at a tip end of the housing K1. The feeding-out assist mechanism 150C includes a roller 158 (first roller), a roller 159 (second roller), a spring 160 (elastic body), and a spring attachment portion 161. The roller 158 is exposed to the outside of the housing K1 from a portion of which a part is cut out in the housing K1, and is rotated by a finger M of the operator. The roller 159 sandwiches the threadlike adhesive 2 with the roller 158, is rotated in conjunction with the rotation of the roller 158, and sandwiches and pulls out the threadlike adhesive 2 in a direction of an arrow F3 (rotation direction). The spring 160 is attached between the roller 159 and the spring attachment portion 161, and the spring attachment portion 161 is fixed to an inner wall of the housing K1. A compression force (degree of collapse) to the threadlike adhesive 2 can be adjusted by the spring 160.

The threadlike adhesive 2 pulled and fed out by the feeding-out assist mechanism 150C is allowed to pass through the cylindrical internal space of the nozzle 107A at the tip end of the housing K1 with low tension, and is led out to the outside of the housing K1. The nozzle 107A is formed of the same material as that of the nozzle 107, and a tip end opening thereof has a circular shape or a polygonal shape having five or more corners. In addition, the nozzle 107A presses the threadlike adhesive 2, which has been allowed to pass through the cylindrical internal space and has been led out to the outside, against the object at the entire circumference or at any positions of the peripheral portion surrounding the tip end opening. That is, the operator holding the housing K1 can stick the threadlike adhesive 2 to the object in any path by pressing the nozzle 107A against the object while rotating the roller 158 with the finger M using the threadlike adhesive sticking apparatus 101A, just like operating a writing instrument such as a pen.

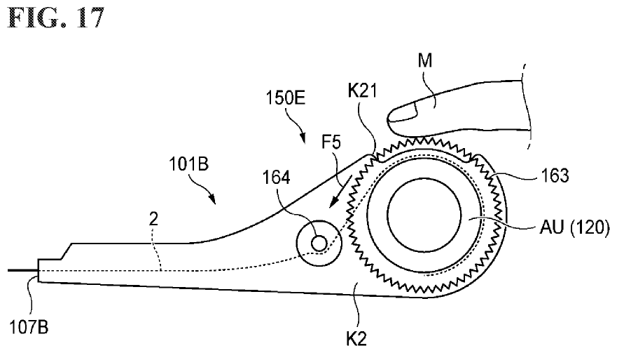

Feeding-out assist mechanisms 150D and 150E shown in FIG. 16 and FIG. 17 apply, to the threadlike adhesive 2, an extrusion force for feeding out the threadlike adhesive 2 by rotating the winding body 120 in the feeding direction.

The feeding-out assist mechanism 150D shown in FIG. 16 includes a surface drive SD and winding body holding rods 162, and holds the winding body 120 in place of the winding body holding unit of the threadlike adhesive sticking apparatus 101. The surface drive SD comes into contact with the threadlike adhesive 2 wound around the winding body 120 or the outer peripheral surface of the winding body 120, and rotatably holds the winding body 120. The surface drive SD is rotationally driven by a motor (not shown) to rotate the winding body 120 in the feeding direction indicated by an arrow F4. The winding body holding rods 162 are disposed on both end sides of the winding body 120, and hold the winding body 120 held by the surface drive SD so as to be rotatable and prevent the winding body 120 from falling off from the surface drive SD. The threadlike adhesive 2 is supplied to the pressing mechanism BU at a low tension by the feeding-out assist mechanism 150D that applies an extrusion force to the threadlike adhesive 2 by rotating the winding body 120.

FIG. 17 illustrates an example in which the feeding-out assist mechanism 150E is provided in a threadlike adhesive sticking apparatus 101B in a mode of being gripped and used by an operator. Members having the same functions as those of the threadlike adhesive sticking apparatus 101 are denoted by the same reference numerals. The threadlike adhesive sticking apparatus 101B includes the supply unit AU (winding body 120) and the feeding-out assist mechanism 150E in a housing K2 having a size and a shape that can be held by one hand of an operator, and has a nozzle 107B at a tip end of the housing K2. The feeding-out assist mechanism 150E has a gear 163 and a roller 164. The gear 163 is attached to the supply unit AU (winding body 120) and rotated together with the winding body 120. The gear 163 is exposed to the outside of the housing K2 from a portion K21 of which a part is cut out in the housing K2, and is rotated by a finger M of the operator. When the gear 163 is rotated by the finger M, an extrusion force is applied to the threadlike adhesive 2.

The extruded threadlike adhesive 2 is guided by the roller 164 to reach the nozzle 107B, is allowed to pass through the cylindrical internal space of the nozzle 107B with low tension, and is led out to the outside of the housing K2. The nozzle 107B has the same configuration as the nozzle 107A. The nozzle 107B presses the threadlike adhesive 2, which has been allowed to pass through the cylindrical internal space and has been led out to the outside, against the object at the entire circumference or at any positions of the peripheral portion surrounding the tip end opening. Therefore, the operator holding the housing K2 can draw any path by pressing the nozzle 107B against the object, rotating the gear 163 with the finger M. Therefore, the operator can stick the threadlike adhesive 2 to the object in any path (in various shapes) using the threadlike adhesive sticking apparatus 101B, just like operating a writing instrument such as a pen. Instead of the feeding-out assist mechanism 150E shown in FIG. 17, the movement of the nozzle 107B (pressing of the threadlike adhesive 2 by the nozzle 107) may be transmitted to a core (rotation shaft) of the winding body 120 by a belt formed of rubber or the like to assist the feeding out of the threadlike adhesive 2. In addition, the feeding out of the threadlike adhesive 2 may be assisted by directly rotating the core of the winding body 120.

Preferably, there is no member such as a roller for applying tension to the threadlike adhesive 2, in a path for conveying the threadlike adhesive 2 between the feeding-out assist mechanisms 150A, 150B, 150Ba, 150C, 150D, and 150E, the pressing mechanism BU (nozzle 107), and the nozzles 107A and 107B. In addition, in the threadlike adhesive sticking apparatus 101, a tension detector may be provided in a path for conveying the threadlike adhesive 2, and the feeding-out assist mechanisms 150A, 150B, and 150D may be controlled according to a detected tension value to feed out the threadlike adhesive 2 so as to have a constant tension. Further, in the above embodiment, an example of sticking the threadlike adhesive 2 to the adherend placed on the stage is shown, but the threadlike adhesive 2 can be stuck to an adherend having a three-dimensional shape such as a curved surface by attaching the nozzle 107 to an articulated robot arm having a degree of freedom of six axes, for example.

### Second Embodiment

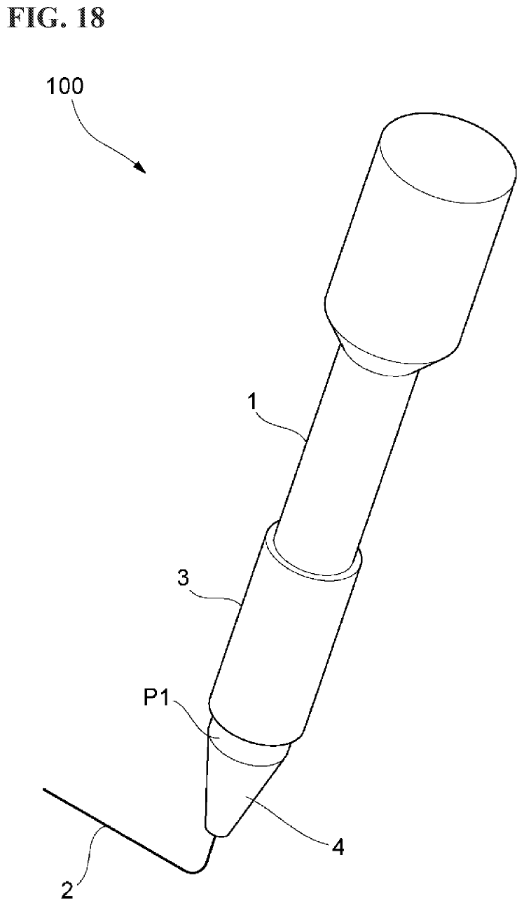

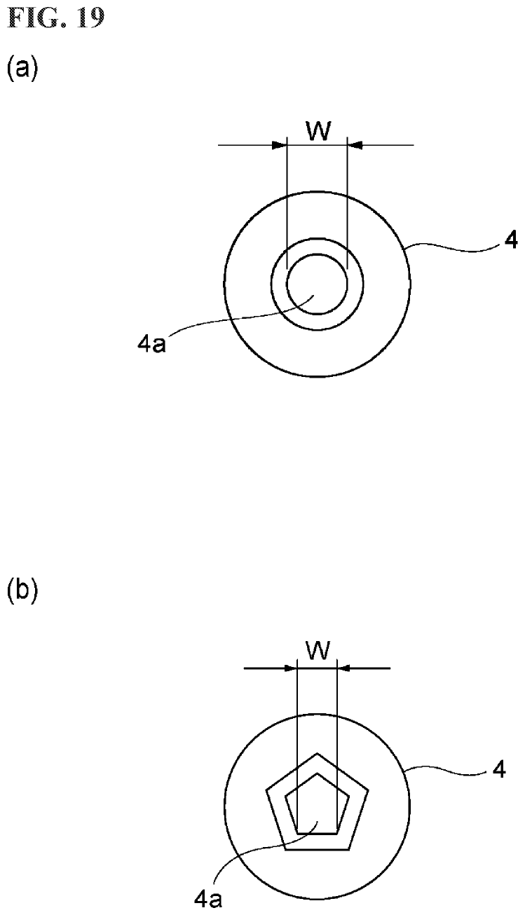

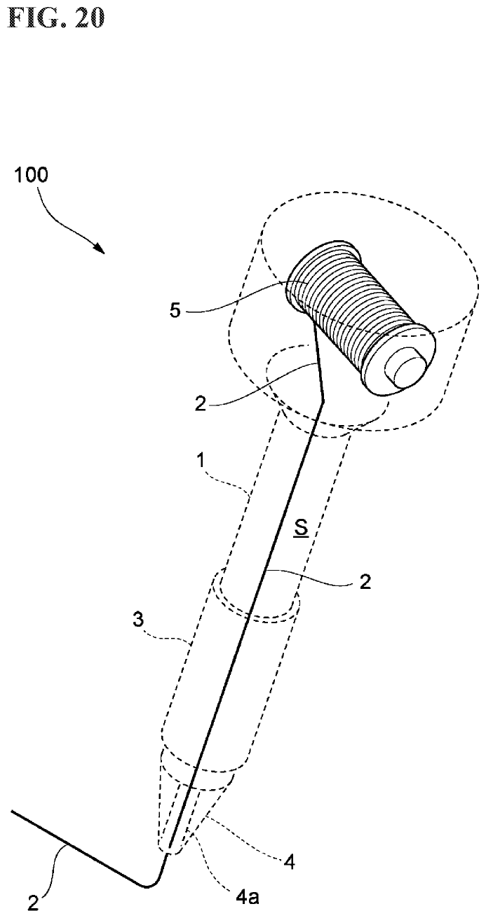

FIG. 18 is a schematic view illustrating a threadlike adhesive sticking apparatus according to a second embodiment of the present invention. As shown in FIG. 18, a threadlike adhesive sticking apparatus 100 of the present embodiment includes a main body 1 having a shaft shape, and a tip end portion 4 detachably provided at both ends of the main body 1. The main body 1 is provided with a grip 3 formed of a resin or the like.

An operator grips the threadlike adhesive sticking apparatus 100 at the portion of the grip 3, presses the tip end portion 4 against an object, which is an adherend of the threadlike adhesive 2, and moves the tip end portion 4 in one direction, whereby the threadlike adhesive 2 can be fed out. That is, the operator can use the threadlike adhesive sticking apparatus 100, just like operating a writing instrument such as a pen, gripping (grip 3 of) the elongated main body 1 having a shaft shape. For example, the operator can operate the threadlike adhesive sticking apparatus 100 as expected even in a narrow location or the like with many obstacles, and can efficiently perform various operations.

The main body 1 has a shaft shape extending in a uniaxial direction. An internal space S having a shaft shape is defined inside the main body 1 as shown in FIG. 18. The tip end portion 4 having a tapered shape is detachably attached to one end (tip end) of the main body 1. A shape of the tip end portion 4 may be a shape having a cylindrical pipe at the tip of the tapered shape, like a tip of a mechanical pencil. A tip end opening 4a is formed at the tip end of the tip end portion 4, and the internal space S of the main body 1 communicates with the outside through the tip end opening 4a (tubular internal space). The tip end portion 4 is defined by a region from a position P1 (FIG. 18) where a cross-sectional area thereof is smaller than that of the main body 1, to the tip end opening 4a. At the other end (rear end) of the main body 1, a winding body capable of winding the threadlike adhesive 2 is attached inside.

In the present embodiment, the tip end portion 4 has a tapered shape of which a cross section becomes smaller toward the tip end, and this improves workability in a narrow location. In addition, when the tip end portion 4 has a cylindrical pipe at the tip of the tapered shape, as the pipe is thinner and longer, workability in a narrower location is improved. The parts (a) and (b) of FIG. 19 are views illustrating an example of the cross-section of the tip end portion 4 as viewed from a tip end opening 4a side. The part (a) of FIG. 19 shows the tip end portion 4 having a circular cross-section and the part (b) of FIG. 19 shows the tip end portion 4 having a pentagonal cross-section. Portions of the peripheral portion of the tip end opening 4a having a circular cross-sectional shape or a polygonal cross-sectional shape having five or more sides function as the pressing portion, and thus, the sticking direction can be easily changed. An overall shape of the tip end portion 4 is not limited, but examples thereof include a conical shape, a quadrangular pyramid shape, and a fountain pen tip shape (saucer shape). The overall shape of the tip end portion 4 may be an extremely elongated straw shape.

A length of the tip end portion 4 shown in FIG. 18 is preferably 3 mm or more, and more preferably 10 mm or more. A width W of the tip end portion 4 shown in the parts (a) and (b) of FIG. 19 is defined by a position where the cross-sectional area of the tip end portion 4 is the smallest, but the width W also corresponds to an inner diameter (diameter) of the tip end portion 4. The minimum cross-sectional area of the tip end portion 4 is preferably in a range of 1.2 to 9 times the cross-sectional area of the threadlike adhesive 2. Thus, for example, when the cross-section of the threadlike adhesive 2 has a circular shape having a diameter of 0.3 mm, the size of the width W of the tip end portion 4 is set in a range of about 0.32 mm to 0.9 mm Such a size is expected to improve workability. In addition, in the threadlike adhesive sticking apparatus 100, the unnecessary movement of the threadlike adhesive 2 is restricted by the tip end opening 4a of the tip end portion 4. Therefore, without using a roller or the like as the pressing portion, the operator can grip the threadlike adhesive sticking apparatus 100 at the portion of the grip 3 and stick the threadlike adhesive 2, moving the tip end portion 4 in any directions. Accordingly, this prevents a problem in the case of pressing the adhesive by the roller, that the adhesion accuracy is poor due to the movement of the adhesive within a roller width, and the adhesive is detached from the roller depending on an adhesion path. Further, when the tip end portion 4 has a cylindrical pipe at the tip of the tapered shape, as the pipe is thinner and longer, workability in a narrower location is improved.

### Third Embodiment

FIG. 20 is a perspective view illustrating an internal structure of a threadlike adhesive sticking apparatus 100 according to a third embodiment. In the present embodiment, at the other end (rear end) of the main body 1, a winding body 5 capable of winding the threadlike adhesive 2 is rotatably attached in a direction perpendicular to an axial direction of the main body 1 as an axis. Since the threadlike adhesive 2 is allowed to pass through the internal space S and goes out from the tip end opening 4a, unnecessary movement is restricted. Further, portions of the peripheral portion of the tip end opening 4a function as the pressing portion, and thus, a sticking direction can be easily changed.

### Fourth Embodiment

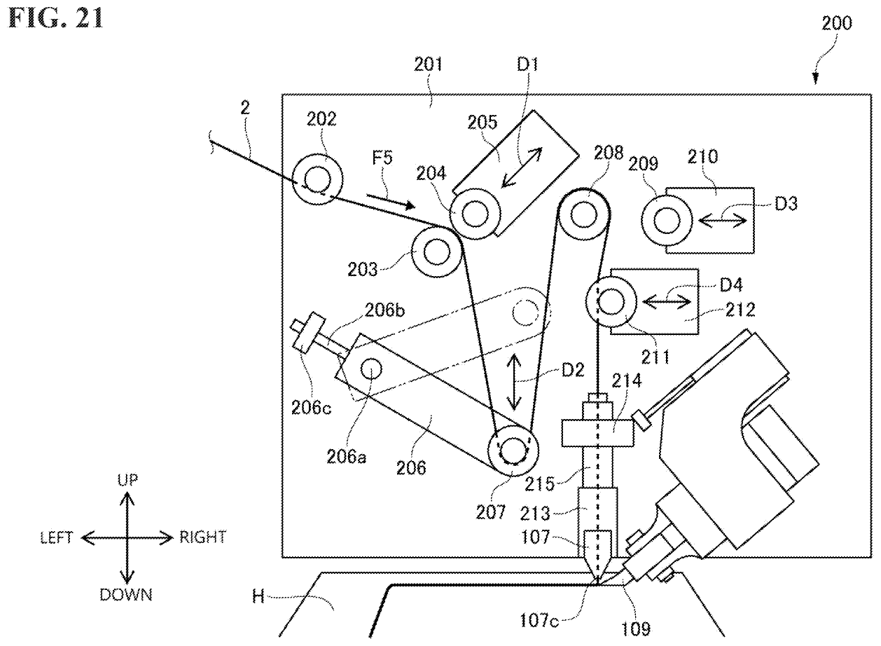

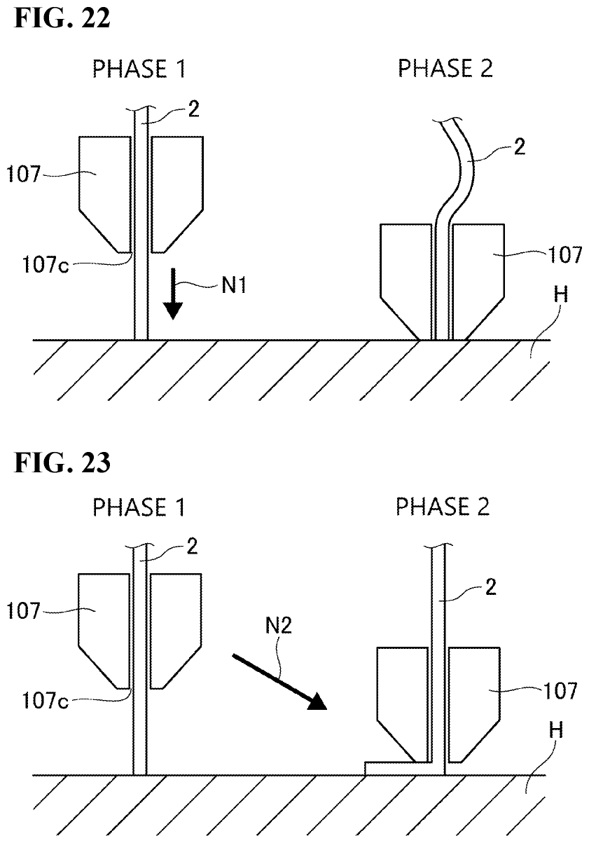

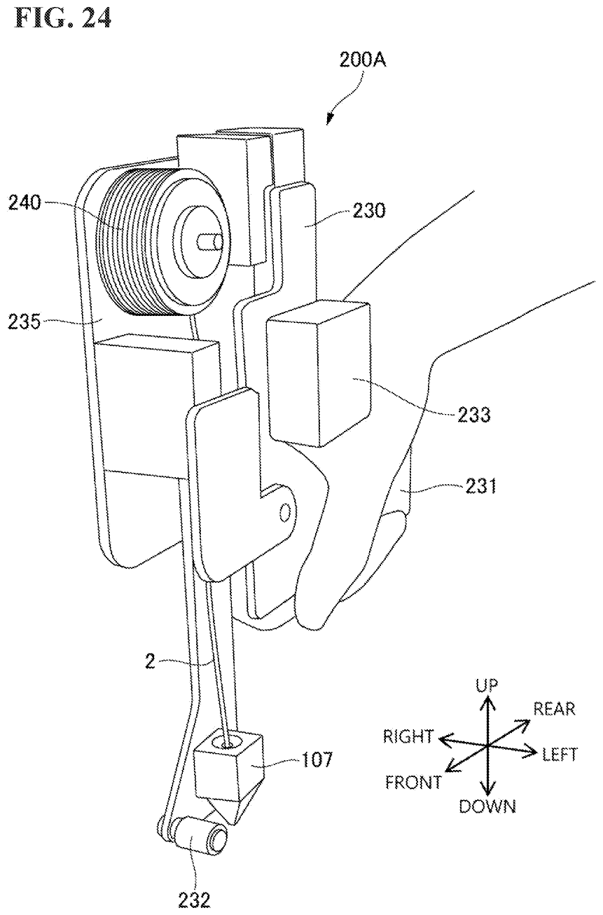

FIG. 21 is a schematic front view illustrating a main part of a threadlike adhesive sticking apparatus 200 according to a fourth embodiment. The threadlike adhesive sticking apparatus 200 is different from the threadlike adhesive sticking apparatus 101 according to the first embodiment in configurations of the pressing mechanism BU and the conveyance unit CU and a configuration for reducing an extra length of the threadlike adhesive 2 at the time of cutting. Hereinafter, differences from the first embodiment will be mainly described, and redundant description will be omitted.

In the threadlike adhesive sticking apparatus 200, main parts of the pressing mechanism BU and the conveyance unit CU are attached to front of an attachment plate 201 having a substantially rectangular shape, and are positioned by the positioning unit DU.

### (Conveyance Unit CU of Threadlike Adhesive Sticking Apparatus 200)

The threadlike adhesive sticking apparatus 200 includes a roller 122 (see FIG. 5), rollers 202, 203, and 204, a moving unit 205, an arm 206, rollers 207, 208, and 209, a moving unit 210, a roller 211, and a moving unit 212 as an example of the conveyance unit CU, and conveys the threadlike adhesive 2 fed out from the supply unit AU (winding body) to the nozzle 107.

The rollers 202, 203, 204, 207, 208, 209, and 211 are configured similarly to the above-described roller 122 and the like, and are rotatably attached to the attachment plate 201 directly or indirectly, in a perpendicular plane (YZ plane). As an example, the rollers 202, 203, 204, 207, 208, 209, and 211 are disposed such that respective rotation positions are at substantially the same distance from the front surface side of the attachment plate 201 (front side of the paper surface in FIG. 21).

The roller 202 is attached to an upper left corner of the attachment plate 201, and guides the threadlike adhesive 2 to the rollers 203 and 204. On the left side of the roller 202 and on the right side of the roller 122 in the frame erected on the left side of the winding body holding unit 121, a roller capable of being moved up and down according to the tension of the threadlike adhesive 2 to be conveyed and a roller provided on the upper right side of the roller (both not shown) may be disposed. The tension of the threadlike adhesive 2 supplied to the roller 202 can be adjusted to be constant by these rollers.

The roller 203 is attached to the attachment plate 201 slightly below the right side of the roller 202. The roller 203 is a feed out roller that is driven and rotated by a motor (not shown).

The roller 204 is disposed on the upper right of the roller 203, and is attached to a lower left end portion of the moving unit 205 such as an air cylinder that is moved (slides) in a direction of an arrow D1 (upper right and lower left directions) with respect to the attachment plate 201. When the roller 204 is located at the lowest left, the roller 204 is rotated in conjunction with the rotation of the roller 203, sandwiches the threadlike adhesive 2 with the roller 203, and pulls out the threadlike adhesive 2 in a direction of an arrow F5.

The arm 206 is a rod-shaped body extending in the left-right direction below the rollers 202 and 203 and the moving unit 205. The roller 207 is attached to the right end portion of the arm 206. A vicinity of the left end portion of the arm 206 is rotatably supported to the attachment plate 201 by a rotation shaft 206a. A potentiometer for calculating a position of the roller 207 is attached to the rotation shaft 206a. The arm 206 is rotated in a direction of an arrow D2 (substantially in up-down direction) by a drive unit such as a motor provided on the rear side of the attachment plate 201, for example. That is, the roller 207 is movable in the up-down direction by the rotation of the arm 206.

A shaft 206b that extends along an extending direction of the arm 206 and is provided with a spiral ridge on the outer peripheral surface thereof, protrudes from the left end portion of the arm 206. One or more weights 206c are attached to the shaft 206b. The weight 206c has a substantially disc shape, and a through hole provided at the center of the weight 206c is formed with a groove to be screwed with the ridge of the shaft 206b. The ease of movement of the arm 206 can be controlled by changing a distance between the weight 206c and the rotation shaft 206a (left end portion of the arm 206) by shifting the position of the weight 206c on the shaft 206b.

The roller 208 is attached to the upper right of the roller 207 and the right side of the roller 204 in the attachment plate 201. The roller 208 guides the threadlike adhesive 2 pulled out by the rollers 203 and 204 to, via the roller 207, the pressing mechanism BU (nozzle 107) provided directly below the roller 208.

When the roller 207 is moved downward (displaced so as to lengthen a path from the rollers 203 and 204 to the roller 208), a conveying speed of the threadlike adhesive 2 decreases. In this way, the threadlike adhesive 2 is fed out by the rollers 203 and 204, and a rapid speed change of the fed threadlike adhesive 2 can be alleviated by the displacement of the roller 207. That is, the rollers 203, 204, 207, and 208 and the arm 206 function as the feeding-out assist mechanism 150Ba shown in FIG. 14.

### (Reduction of Extra Length in Threadlike Adhesive Sticking Apparatus 200)

On the right side of the roller 208, i.e., above the nozzle 107, a roller 209 attached to a left end portion of the moving unit 210 that is moved in a direction of an arrow D3 (left-right direction) with respect to the attachment plate 201 is disposed. The roller 209 is disposed adjacent to the roller 203 so that the threadlike adhesive 2 can be nipped between the roller 209 and the roller 208 when the roller 209 is positioned at the leftmost position. The roller 209 provided upstream of the nozzle 107 nips (chucks) the threadlike adhesive 2 with the roller 208 when the sticking of the threadlike adhesive 2 is completed and the nozzle 107 is raised. In this state, the threadlike adhesive 2 is cut at a position close to an adherend H.

In the first embodiment, the threadlike adhesive 2 is chucked below (downstream of) the nozzle 107 by the air chuck 108, whereas in the present embodiment, the roller 209 is provided upstream of the nozzle 107 and chucks the threadlike adhesive 2 with the roller 208 that conveys the threadlike adhesive 2. With this configuration, since a space for the air chuck 108 below the nozzle 107 can be reduced, an extra length at the time of cutting (end point) can be reduced.

The roller 211 is disposed below the rollers 208 and 209 and the moving unit 210, that is, above the nozzle 107, and is attached to the left end portion of the moving unit 212 that is moved in a direction of an arrow D4 (left-right direction) with respect to the attachment plate 201. As an example, when the roller 211 is positioned on the right side, the roller 211 allows the threadlike adhesive 2 to pass through and guides the threadlike adhesive 2 into the nozzle 107, and when the threadlike adhesive 2 is cut, the roller 211 is moved to the left side to press the threadlike adhesive 2 in a left direction, and moves the cut tip end portion (lower end portion) of the threadlike adhesive 2 upward. Raising the lower end portion of the threadlike adhesive 2 after cutting the threadlike adhesive 2 allows for reducing the extra length at the start of the next sticking of the threadlike adhesive 2 (start point). When the threadlike adhesive 2 is allowed to pass through the right side of the roller 211, the roller 211 is moved to the right side to pull the threadlike adhesive 2 in a right direction, so that the lower end portion of the threadlike adhesive 2 can be moved upward.

The extra length of the threadlike adhesive 2 may be reduced by rotating the roller 203 or the like in a reverse direction. However, it is concerned that this may cause a problem that the threadlike adhesive 2 may be wound around the roller 203 or the like and may not be wound around the winding body due to the reverse rotation. In this regard, as described above, nipping and cutting the threadlike adhesive 2 by using the rollers 208 and 209 and then raising the lower end portion of the threadlike adhesive 2 by the roller 211 allow for reducing the extra length of the end point and the start point without the above-described problem.

A guide rod (not shown) erected on the front of the attachment plate 201 may be provided below the roller 211. A surface (outer peripheral surface) of the guide rod is a non-adhesive surface, and thus the guide rod allows for restricting the displacement of the threadlike adhesive 2 in the left direction.

### (Pressing Mechanism BU of Threadlike Adhesive Sticking Apparatus 200)

The threadlike adhesive sticking apparatus 200 includes the nozzle 107, a slider 213, a fixing unit 214, and a spring 215 as an example of the pressing mechanism BU, and sticks the threadlike adhesive 2 conveyed to the conveyance unit CU to the adherend H. The pressing mechanism BU is provided below the roller 211 and the moving unit 212 on the attachment plate 201.

The nozzle 107 is fixed to the front of the slider 213, and the tip end opening 107c can protrude from the lower end of the attachment plate 201. The slider 213 is movable in the up-down direction with respect to the attachment plate 201 by a linear guide or the like.

In the attachment plate 201, the fixing unit 214 is fixed above the slider 213. The fixing unit 214 holds the spring 215, with a shaft inserted therein, with the upper surface of the slider 213.

As described above, as in the first embodiment, the nozzle 107 of the present embodiment includes an absorption mechanism that is movable in the up-down direction and configured to absorb a displacement of the nozzle 107 with respect to a displacement of a base to which the nozzle 107 is attached in the up-down direction.

Further, the air scissor 109 (nipper) is disposed on the right side of the pressing mechanism BU in the attachment plate 201. The air scissor 109 is moved obliquely to the lower left from a normal position by a driving unit, and cut the threadlike adhesive 2 directly below the nozzle 107. At this time, as described above, since the threadlike adhesive 2 is chucked above the nozzle 107 (with the rollers 208 and 209), the air chuck 108 is unnecessary. Therefore, a distance between the nozzle tip end 107c and the threadlike adhesive 2 attached to the adherend H can be reduced, and the extra length at the time of cutting (end point) can be reduced.

(Improvement of Sticking with Short Extra Length)

The movement of the nozzle 107 in the sticking start point creation when the extra length is short will be described with reference to the parts (a) and (b) of FIG. 22 and the parts (a) and (b) of FIG. 23. When the extra length is short at the start of sticking of the threadlike adhesive 2, as shown in the part (b) of FIG. 22, the threadlike adhesive 2 may enter the inside of the nozzle 107, and the start point may not be attached to the adherend H when the nozzle 107 is vertically lowered in a direction of an arrow N1 shown in the part (a) of FIG. 22. Therefore, when the nozzle 107 is lowered in an oblique direction (direction of an arrow N2) from the state shown in the part (a) of FIG. 23, the start point can be created without allowing the threadlike adhesive 2 to enter the nozzle 107, as shown in the part (b) of FIG. 23.

As described above, the threadlike adhesive sticking apparatus 200 includes the feeding-out assist mechanism (the rollers 203, 204, 207, and 208 and the arm 206) and the configuration for reducing the extra length (the rollers 208 and 209 that chuck the threadlike adhesive 2 upstream of the nozzle 107, and the roller 211 that presses/pulls the cut threadlike adhesive 2 upstream of the nozzle 107). This configuration, in addition to the same effect as that of the first embodiment, allows for conveying the threadlike adhesive 2 at a low tension and reducing the extra length at the start and end of sticking. Therefore, the threadlike adhesive 2 can be stuck at high speed without waste.

### Fifth Embodiment

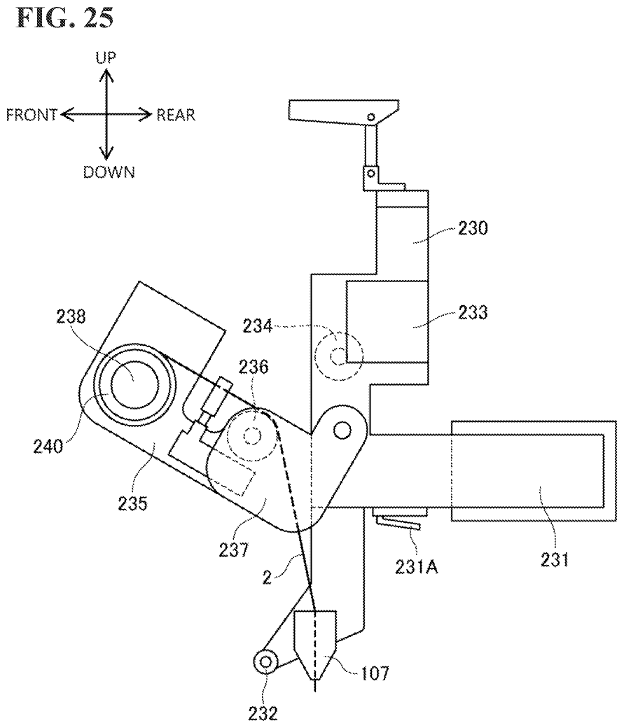

FIG. 24 is a perspective view illustrating a threadlike adhesive sticking apparatus 200A according to a fifth embodiment. FIG. 25 is a front view illustrating a state where an opening/closing frame 235 is opened in the threadlike adhesive application device 200A according to the fifth embodiment. The threadlike adhesive sticking apparatus 200A mainly includes a main body frame 230, a gripping portion 231, and an opening/closing frame 235 in which a winding body 240 capable of winding the threadlike adhesive 2 is held.

In the main body frame 230, a lower portion of an elongated plate member extending in the up-down direction is bent in an oblique direction to be tapered. The nozzle 107 is fixed to the bent portion of the main body frame 230, and a pressing roller 232 is provided at the tapered lower end. As shown in FIG. 25, the nozzle 107 is attached along an axial direction of the main body frame 230. In addition, the pressing roller 232 is disposed at a position slightly above the tip end opening 107c on the front side of the tip end opening 107c of the nozzle 107. The pressing roller 232 is rotatably attached to the main body frame 230 in a vertical plane. The function of the pressing roller 232 will be described later.

A motor 233 and a roller 234 driven by the motor 233 are attached to substantially the center of the main body frame 230. The roller 234 is rotatably attached to the opening/closing frame 235 in the vertical plane, and sandwiches the threadlike adhesive 2 with a roller 236 rolling in accordance with the rotation of the roller 234 to feed out the threadlike adhesive 2 from the winding body 240. That is, the rollers 234 and 236 function as a feeding-out assist mechanism. The motor is provided with a speed volume (not shown) for adjusting a rotation speed of the motor 233, that is, for manually adjusting a feed-out speed of the threadlike adhesive 2.

The gripping portion 231 having a substantially rectangular plate shape is provided slightly below the center of the main body frame 230 so as to protrude rearward. The gripping portion 231 is gripped by an operator. The gripping portion 231 is provided with a switch 231A for switching on/off of the motor 233 to start/stop feed out of the threadlike adhesive 2. As an example, the switch 231A is provided at a position where the operator can easily operate the switch 231A with an index finger in a state where the operator grips the gripping portion 231, the switch 231A turns on the motor 233 while the switch 231A is pressed and turns off the motor 233 when the switch 231A is released from the pressing (that is, when the switch 231A is not pressed).

The opening/closing frame 235 includes a roller holding unit 237 configured to rotatably hold the roller 236 in the vertical plane, and a winding body holding unit 238 configured to rotatably hold the winding body 240 in the perpendicular plane. The opening/closing frame 235 is pivotally supported by the main body frame 230 at the rear of the lower end side, and can be opened and closed with respect to the main body frame 230.

In an open state shown in FIG. 25, the operator sets the winding body 240 in the winding body holding unit 238, and inserts the threadlike adhesive 2 into the inside of the nozzle 107 via the rotation surface of the roller 236. Then, the operator rotates the opening/closing frame 235, on which the winding body 240 is set, rearward to close the opening/closing frame 235, and engages the upper end of the opening/closing frame 235 with the main body frame 230 to bring the opening/closing frame 235 into a closed state shown in FIG. 24.

As shown in FIG. 24, the operator grasps the gripping portion 231 to bring the tip end (tip end opening 107c) of the nozzle 107 close to the adherend. At this time, when the extra length of the threadlike adhesive 2 is short, the operator lowers the nozzle 107 in an oblique direction as shown in the parts (a) and (b) of FIG. 23, so that the start point can be reliably created without allowing the threadlike adhesive 2 to enter the nozzle 107.

When the operator operates the switch 231A, the motor 233 is rotated, and the rollers 234 and 236 feed out the threadlike adhesive 2 from the winding body 240 by the rotation of the motor 233. When the operator moves the nozzle 107 on the adherend in any direction, the threadlike adhesive 2 fed out from the winding body 240 is stuck to the adherend in any path.

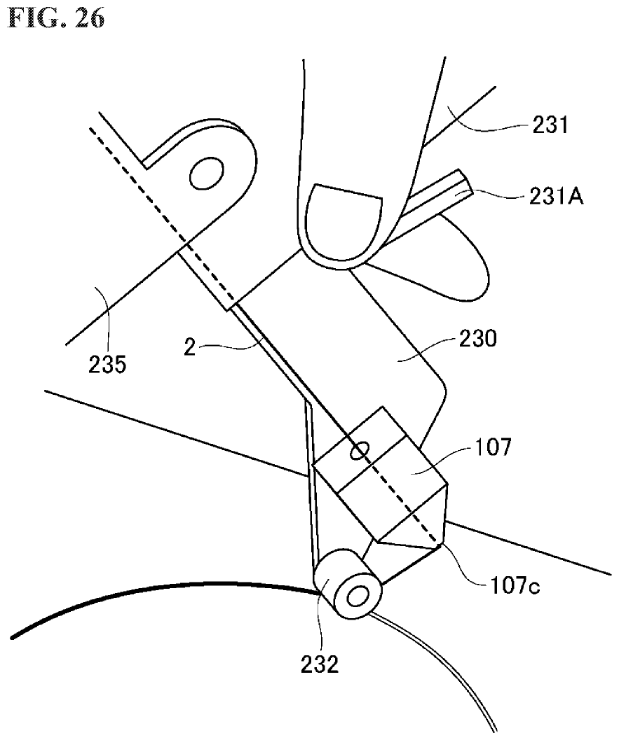

FIG. 26 shows a state where the threadlike adhesive 2 is cut at the end of the sticking operation using the threadlike adhesive sticking apparatus 200A. When the sticking operation ends, the operator operates (releases the pressing of) the switch 231A to stop the rotation of the motor 233. At an end point position, as shown in FIG. 26, the operator tilts the main body frame 230 with respect to a vertical direction, and presses the threadlike adhesive 2 against the adherend by the pressing roller 232. Pressing the threadlike adhesive 2 with the pressing roller 232 allows for preventing a stuck portion (end point of the threadlike adhesive 2) from being lifted and debonded.

The operator cuts the threadlike adhesive 2 in the vicinity of the end point with a scissor 241 in a state where the end point is pressed by the pressing roller 232 as described above. Since the pressing roller 232 is provided in the vicinity of the nozzle 107, the operator can prevent debonding of the end point of the threadlike adhesive 2 by a simple operation of merely gripping and tilting the threadlike adhesive attaching device 200A (main body frame 230).

As described above, the threadlike adhesive sticking apparatus 200A of the present embodiment allows for easily changing the sticking direction since a plurality of portions of the peripheral portion of the tip end opening 107c of the nozzle 107 function as the pressing portion, similarly to the second embodiment, though the workability in a narrow location is better in the threadlike adhesive sticking apparatus 100 of the second embodiment. Therefore, the operator can stick the threadlike adhesive 2, gripping the gripping portion 231 and moving the threadlike adhesive 2 in any direction.

### Sixth Embodiment

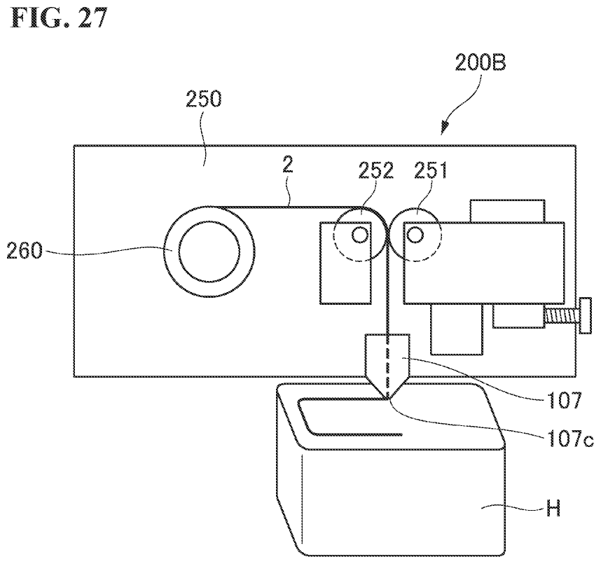

FIG. 27 is a schematic view illustrating a threadlike adhesive sticking apparatus 200B according to a sixth embodiment. The threadlike adhesive sticking apparatus 200B includes an attachment plate 250, rollers 251 and 252 provided on the attachment plate 250, and the nozzle 107. A winding body 260 capable of winding the threadlike adhesive 2 is rotatably held by the attachment plate 250 in a vertical plane. The threadlike adhesive sticking apparatus 200B is a stationary sticking apparatus in which, for example, the attachment plate 250 is fixedly disposed and used on a table with a support frame.

The rollers 251 and 252 are disposed on a side (right side in FIG. 27) of the winding body 260 on the front surface side of the attachment plate 250. The roller 251 is driven by a motor provided on the rear side of the attachment plate 250. The roller 252 sandwiches the threadlike adhesive 2 with the roller 251, and is rotated with the rotation of the roller 251. The rotation of the rollers 251 and 252 causes the threadlike adhesive 2 to be fed out from the winding body 260. The nozzle 107 is fixed below (directly below) the rollers 251 and 252 at the lower end of the attachment plate 250.

The operator drives the motor to feed out the threadlike adhesive 2, brings the adherend H into contact with the tip end opening 107c of the nozzle 107, and sticks the threadlike adhesive 2 in any path, moving the adherend H. At the end of the sticking, the driving of the motor is stopped, and the threadlike adhesive 2 is cut by a scissor or the like.

As described above, according to the threadlike adhesive sticking apparatus 200B according to the sixth embodiment, the operator can stick the threadlike adhesive 2 to the adherend H having a planar or three-dimensional shape in any path by gripping the adherend H and moving the adherend H with the adherend H brought into contact with the tip end opening 107c of the nozzle 107.

### (Details of Threadlike Adhesive 2)

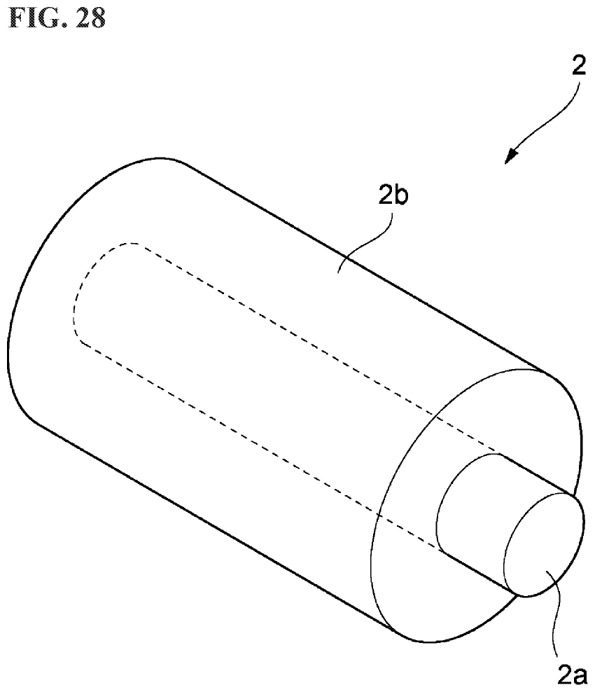

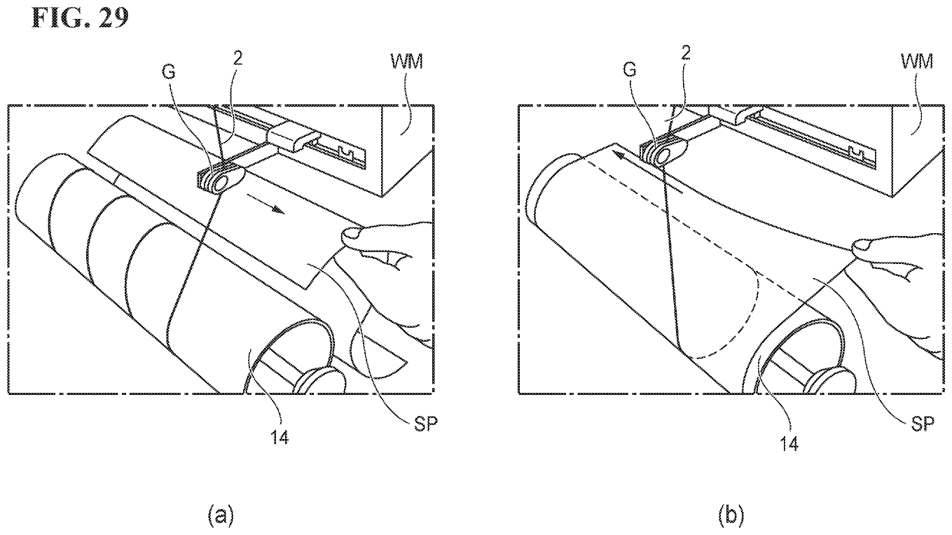

FIG. 28 shows a schematic view of the threadlike adhesive 2 used in the threadlike adhesive sticking apparatuses 100, 101 and the like according to the first to sixth embodiments. The threadlike adhesive 2 includes a linear adhesive body including a linear core material 2a and an adhesive layer 2b that covers a surface of the core material 2a in a longitudinal direction.

The threadlike adhesive 2 is an elongated adhesive body and has a linear shape. The linear shape mentioned here is a concept including not only a straight line shape, a curved line shape, a polygonal line shape, and the like, but also a state in which a material can be bent in various directions and angles like a filament (i.e., threadlike). In addition, the adhesive layer in the present specification also includes a linear adhesive layer.

A cross-sectional shape of the threadlike adhesive 2 in the present configuration example is a circular shape, though the present embodiment is not limited to a specific shape. The cross-sectional shape may be an elliptical shape, a rectangular shape such as a quadrangular shape, or the like, in addition to the circular shape.

The adhesive layer 2b contains an adhesive formed of an adhesive composition. The adhesive is not limited as long as the adhesive satisfies the above gel fraction and the above amount of a change in the gel fraction, and a known adhesive can be used. Examples of the adhesive include an acrylic-based adhesive, a rubber-based adhesive, a vinyl alkyl ether-based adhesive, a silicone-based adhesive, a polyester-based adhesive, a polyamide-based adhesive, a urethane-based adhesive, a fluorine-based adhesive, and an epoxy-based adhesive. Among these adhesives, an acrylic-based adhesive, a urethane-based adhesive, a silicone-based adhesive, a rubber-based adhesive, or a polyester-based adhesive is preferable, and an acrylic adhesive is particularly preferable from the viewpoint of adhesiveness. The adhesive may be used alone or in combination of two or more kinds thereof. The adhesive in this embodiment is preferably a pressure-sensitive adhesive, which has adhesiveness at room temperatures and can be stuck to a surface of an adherend by a pressure generated when a surface of the adhesive and the surface of the adherend are brought into contact with each other. When the adhesive is a pressure-sensitive adhesive, the adhesive does not need to be heated and can be applied to an adherend that is sensitive to heat.

As the adhesive, either a solvent-type adhesive or a water-dispersible type adhesive can be used. The adhesive is preferably an adhesive obtained by performing crosslinking by drying (solvent volatilization) an adhesive composition and rapidly completing the crosslinking after drying. This is because new crosslinking is avoided to increase after surfaces of adhesive layers come into contact with one another. Here, a water-dispersible type adhesive is preferable and a water-dispersible type acrylic adhesive is more preferable, as such an adhesive enables high-speedily coating, is friendly to the environment, and has a small influence on a base material or a core material (swelling or dissolution).

In the adhesive body having a core material, an adhesive layer may cover the entire surface of the core material (a surface in a longitudinal direction), or may cover at least a part of the surface of the core material. Though an adhesive layer is typically formed to be continuous, the adhesive layer is not limited to such a form, and may be formed in a regular or random pattern such as a dot pattern or a stripe pattern. An end surface of the core material may or may not be covered with an adhesive layer. For example, when the adhesive body is cut during a producing process or during use, the end surface of the core material may not be covered with the adhesive layer.

As the core material used in the threadlike adhesive 2, for example, a resin, a rubber, a foam, an inorganic fiber, a composite thereof, or the like can be used. Examples of the resin include: polyolefins such as polyethylene (PE), polypropylene (PP), an ethylene-propylene copolymer, and an ethylene-vinyl acetate copolymer; polyesters such as polyethylene terephthalate (PET); a vinyl chloride resin; a vinyl acetate resin; a polyimide resin; a polyamide resin; and a fluorine-based resin. Examples of the rubber include a natural rubber, and a synthetic rubber such as a urethane rubber. Examples of the foam include a foamed polyurethane and a foamed polychloroprene rubber. Examples of the fiber include a glass fiber, a carbon fiber, a metal fiber, a chemical fiber (a regenerated fiber, a semi-synthetic fiber, a synthetic fiber, etc.), and a natural fiber (a plant fiber, an animal fiber, etc.). A cross-sectional shape of the core material is not limited, and is usually a cross-sectional shape corresponding to a cross-sectional shape of the adhesive body.

Examples of a material of the threadlike core material that can be used in the threadlike adhesive 2 include various polymer materials such as rayon, cupra, acetate, promix, nylon, aramid, vinylon, vinylidene, polyvinyl chloride, polyester, acrylic, polyethylene, polypropylene, polyurethane, polyclal, and polylactic acid; glass, carbon fiber, various rubbers such as natural rubber and synthetic rubber such as polyurethane; natural materials such as cotton and wool; and metal. A form of the threadlike core material may be a monofilament, a multifilament, a spun yarn, a processed yarn, which has been subjected to crimping or bulking and called a textured yarn, a bulky yarn, and a stretch yarn, or combined yarns obtained by twisting them together, or the like. The cross-sectional shape is not limited to only a circle, and may be a rectangular shape such as a square shape, a star shape, an elliptical shape, a hollow shape, and the like.

The core material may contain various additives such as a filler (an inorganic filler, an organic filler, etc.), an anti-aging agent, an antioxidant, an ultraviolet absorber, an antistatic agent, a lubricant, a plasticizer, and a colorant (a pigment, a dye, etc.) as necessary. A known or common surface treatment such as a corona discharge treatment, a plasma treatment or application of an undercoat agent may be performed on the surface of the core material.

A size of a cross-section of the core material is not limited and may be appropriately selected depending on a purpose. For example, when the cross-sectional shape of the core material is a circular shape, a diameter of the cross-sectional shape of the core material is preferably 1 μm to 2000 μm, and more preferably 10 μm to 1000 μm from the viewpoint of handleability (flexibility, difficulty in cutting).

A thickness of the adhesive layer is not limited, but is, for example, preferably 1 μm or more, and more preferably 3 μm or more from the viewpoint of adhesiveness. The thickness of the adhesive layer is, for example, preferably 200 μm or less, and more preferably 150 μm or less from the viewpoint of thickness unevenness and drying properties. Further, the thickness can be increased by stacking layers according to an application.

In particular, the threadlike adhesive 2 is preferably a pressure-sensitive adhesive body in which the adhesive forming the adhesive layer 2b has adhesiveness at room temperature and that can be stuck to a surface of an adherend by a pressure generated when a surface of the adhesive and the surface of the adherend are brought into contact with each other. When the adhesive body is a pressure-sensitive adhesive body, the adhesive body does not need to be heated and can be applied to an adherend that is sensitive to heat.

As described above, the shape of the threadlike adhesive 2 is not limited. The larger ratio (major axis/minor axis) of a length of the major axis (the longest axis that passes through the center of gravity of the cross-sectional shape) to a length of the minor axis (the shortest axis that passes through the center of gravity of the cross-sectional shape) of the cross-sectional shape of the threadlike adhesive 2 equates to the flatter shape of the threadlike adhesive 2. On the other hand, as the ratio becomes smaller, the cross-sectional shape of the threadlike adhesive 2 comes close to a circular shape. When the cross-sectional shape of the threadlike adhesive 2 is a circular shape, the ratio has a minimum value of 1. When the minimum value is 1, the cross-sectional shape of the threadlike adhesive 2 also includes a special shape such as a triangle and a star shape.

The threadlike adhesive 2 may have a release liner. When the threadlike adhesive 2 has a release liner, the release liner is debonded from the adhesive layer before the threadlike adhesive 2 reaches the nozzle 107 or the like, and the adhesive body is stuck to the object. The threadlike adhesive 2 has the release liner, and thus, the self-adhesion force of the adhesive can be reduced, and the threadlike adhesive 2 can be pressed against an object in a state where the tension of the threadlike adhesive 2 is reduced. Therefore, the release liner allows for preventing a problem that the threadlike adhesive 2 pressed against the object is debonded, cut, re-stuck, and entangled by tension, and allows for smoothly sticking of the threadlike adhesive 2.

Embodiments and usage methods of the threadlike adhesive 2 are roughly classified into the following four patterns. Here, a non-adhesive layer is a layer that covers a surface (a surface in the longitudinal direction) of the adhesive body, and the non-adhesive layer includes, for example, a layer that covers the adhesive body in an initial state before stretching and is cut out by stretching the adhesive body to exhibit adhesiveness of the adhesive body. A type, a material, and the like of the non-adhesive layer are not limited.

1) An adhesive body without a non-adhesive layer is directly press-bonded.
2) An adhesive body without a non-adhesive layer+a release liner (the release liner is debonded before press-bonding)
3) An adhesive body covered with a non-adhesive layer
4) An adhesive body covered with a non-adhesive layer+a release liner (the release liner is debonded before press-bonding)

Hereinafter, as seventh and eighth embodiments, an example of pressing a threadlike adhesive wound in a roll shape together with a release liner (release liner-attached threadlike adhesive) against an object with the threadlike adhesive fed out, in the threadlike adhesive sticking apparatuses 100, 101, 101A, 101B, 200, 200A, and 200B of the first to sixth embodiments, will be described. In the threadlike adhesive sticking apparatus 100 or the like, the threadlike adhesive 2 wound in a roll shape together with the release liner is debonded from the release liner before the threadlike adhesive 2 reaches the nozzle 107 or the like, and then the threadlike adhesive 2 is pressed against the object. The use of the threadlike adhesive 2 wound in a roll shape together with the release liner allows for pressing the threadlike adhesive 2 against the object in a state where the tension of the threadlike adhesive 2 at the time of feeding is reduced, as the threadlike adhesives 2 do not bond to each other. Therefore, it is possible to prevent a problem that the threadlike adhesive 2 pressed against the object is debonded, cut, re-stuck, and entangled by tension, and to smoothly stick the threadlike adhesive 2.

A release liner-attached threadlike adhesive according to the seventh embodiment of the present invention includes a threadlike adhesive and a release liner. A compression elastic modulus of the release liner is 1.5 MPa or less.

A release liner-attached threadlike adhesive according to the eighth embodiment of the present invention includes a threadlike adhesive and a release liner. The release liner is formed with a slit, and at least a part of the threadlike adhesive is disposed in the slit.

As an example, the release liner-attached threadlike adhesive is wound into a roll shape as follows. The parts (a) and (b) of FIG. 29 are diagrams illustrating a specific example of a winding method of the release liner-attached threadlike adhesive. As shown in the parts (a) and (b) of FIG. 29, a guide G of a winding machine WM reciprocates in a width direction of a reel 14 (paper tube, winding core), and the threadlike adhesive 2 is traverse-wound (twill-wound) around the reel 14 over a predetermined width. As shown in the part (a) of FIG. 29, when the threadlike adhesive 2 comes to a right (or left) end of the reel 14 in the width direction, a release liner SP is sandwiched therebetween. The release liner SP is a sheet (paper) having a size having a width at least the predetermined width and at least an outer circumference of the reel 14. The upper limit of the length of the release liner 12 is preferably about twice the outermost circumference during the winding, that is, about twice the outermost circumference when the threadlike adhesive 2 and the release liner SP are wound around the reel 14, from the viewpoint of convenience. As shown in the part (b) of FIG. 29, when the guide G is moved in the width direction, the threadlike adhesive 2 is wound around the reel 14 in a roll shape via the release liner SP. The sandwiching of the release liner SP shown in the part (a) of FIG. 29 is preferably performed automatically. When the release liner-attached threadlike adhesive thus wound in a roll shape is fed out, the release liner SP is naturally debonded (dropped). Thus, in the threadlike adhesive sticking apparatuses 101, 200, 200A, and 200B, when the release liner-attached threadlike adhesive is used, the threadlike adhesive 2 debonded from the release liner is supplied to the pressing mechanism BU and is pressed against the object by the nozzle 107, and thus, it is possible to smoothly stick the threadlike adhesive. In addition, in the threadlike adhesive sticking apparatuses 100, 101A, and 101B, the release liner-attached threadlike adhesive can be used by providing a space into which the release liner SP falls in the housing or by allowing the release liner SP to fall to the outside from an opening portion provided in the housing.

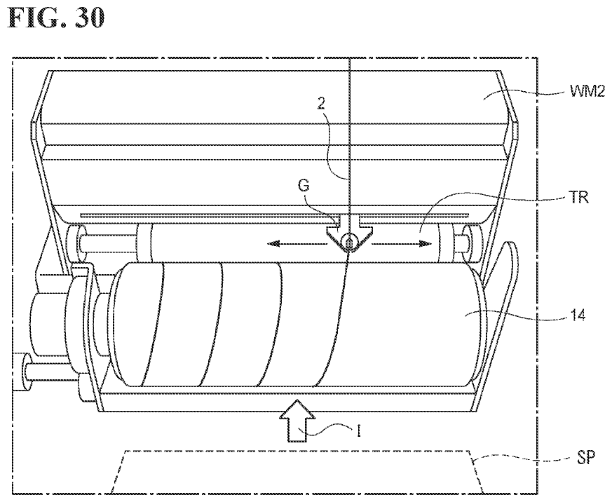

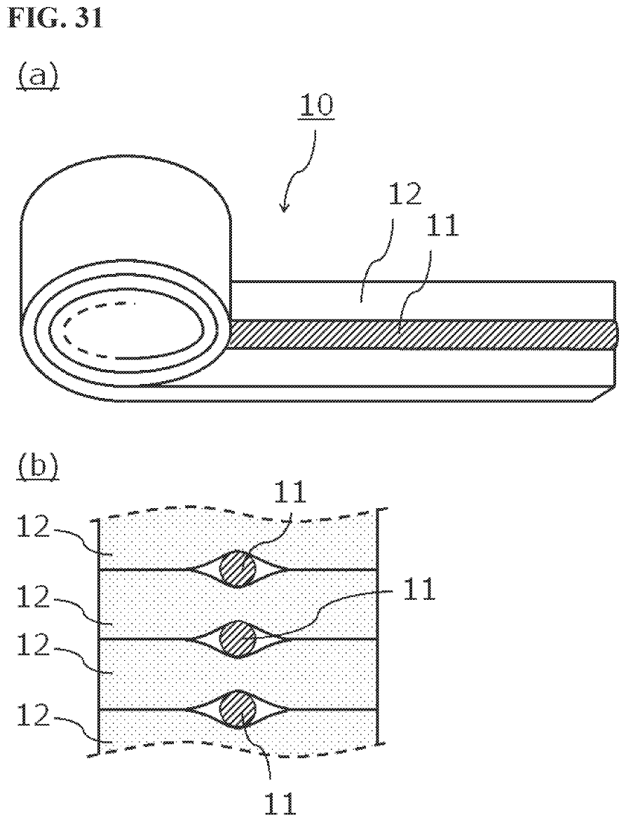

For the winding of the release liner-attached threadlike adhesive, a winding machine WM2 shown in FIG. 30 may be used instead of the winding machine WM shown in the parts (a) and (b) of FIG. 29. The winding machine WM2 is made by adding the winding machine WM with a touch roll unit TR. The touch roll unit TR is provided parallel to the reel 14 below the guide G configured to reciprocate in the width direction of the reel 14, and the touch roll unit TR is configured to press the surface of the reel 14 (via the threadlike adhesive 2 and the release liner SP). When the threadlike adhesive 2 comes to the right (or left) end of the reel 14 in the width direction, the release liner SP is inserted in a direction indicated by an arrow I, the release liner SP is positioned between the reel 14 and the touch roll unit TR, and the release liner SP is sandwiched between the reel 14 and the touch roll unit TR. In this state, when the guide G is moved in the width direction, the threadlike adhesive 2 is wound around the reel 14 in a roll shape via the release liner SP. At the time of the winding, when the release liner SP is pressed against the reel 14 with the touch roll unit TR, the release liner-attached threadlike adhesive can be wound up without loosening.

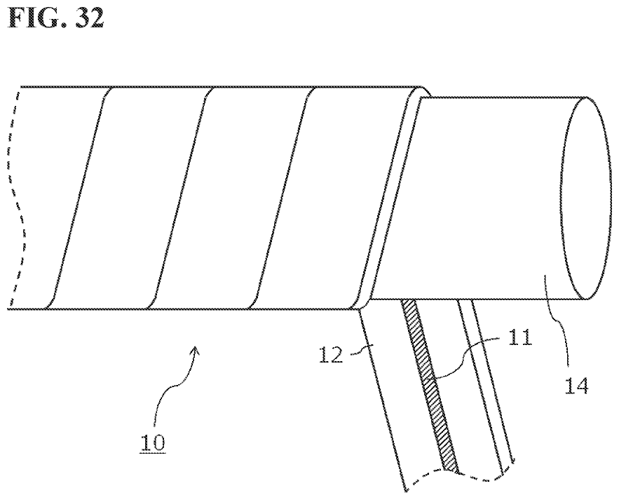

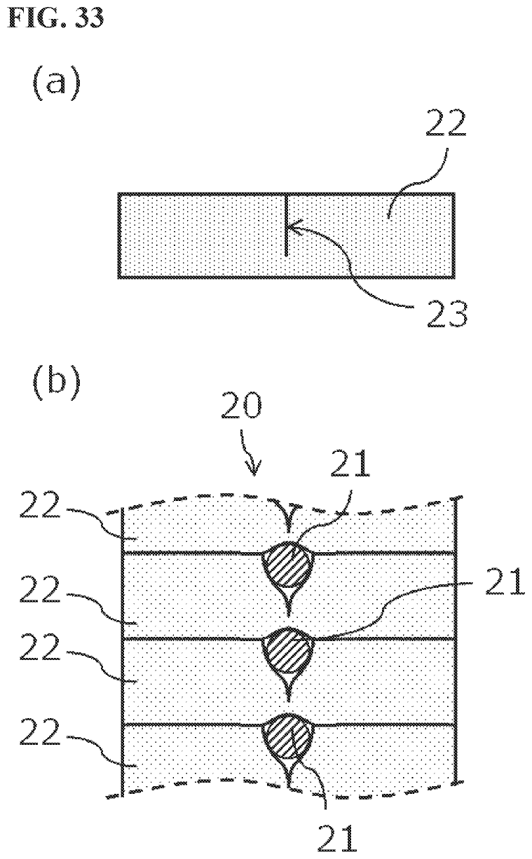

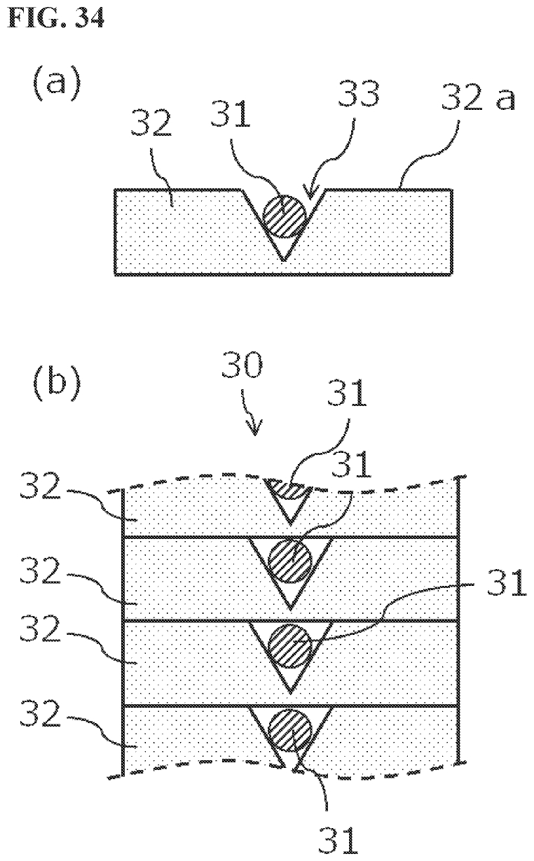

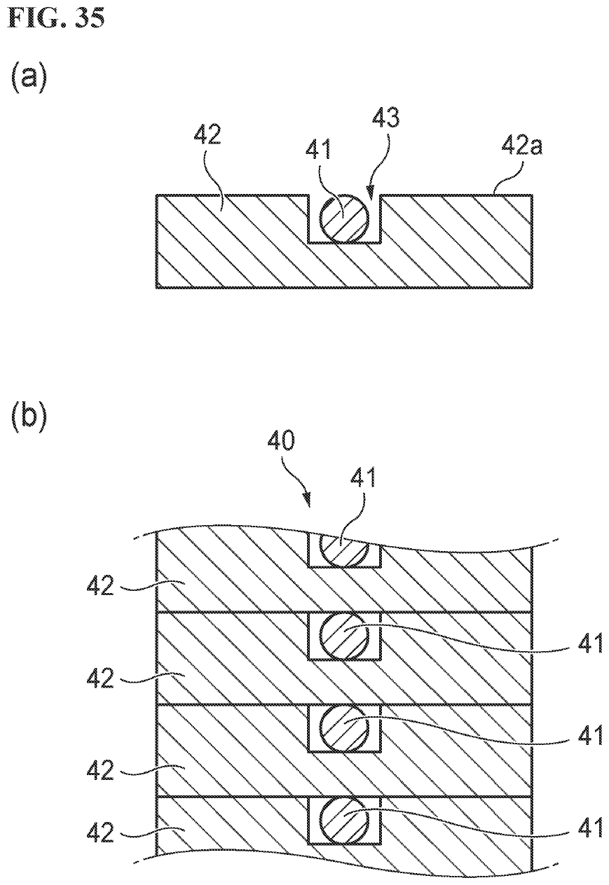

In addition, in the threadlike adhesive sticking apparatuses 101, 200, 200A, and 200B, when a release liner-attached threadlike adhesive 10 wound as shown in the part (a) of FIG. 31 or FIG. 32 described later is used, a release liner 12 is debonded and wound immediately before the nozzle 107 (pressing unit), and a threadlike adhesive 11 is pressed against an object by the nozzle 107. Also in the threadlike adhesive sticking apparatuses 100, 101A, and 101B, debonding and winding the release liner 12 just before the pressing unit like a correction tape allows for pressing the threadlike adhesive 11 debonded from the release liner-attached threadlike adhesive 10 against an object and allows the threadlike adhesive 11 to be smoothly stuck. When the release liner-attached threadlike adhesive is used in a stationary threadlike adhesive sticking apparatus, the release liner may be wound up by an automatic machine.

### Seventh Embodiment

A release liner-attached threadlike adhesive according to the seventh embodiment of the present invention includes a threadlike adhesive and a release liner. A compression elastic modulus of the release liner has is 1.5 MPa or less. The compression elastic modulus of the release liner in the present embodiment is preferably 1.2 MPa or less, and more preferably 1 MPa or less. The lower limit of the compression elastic modulus of the release liner in the present embodiment is not limited, but is, for example, 0.001 MPa or more from the viewpoint of obtaining appropriate strength.

The compression elastic modulus can be measured by the method shown below.

The compression elastic modulus of the release liner can be measured by the following compression test using, for example, an autograph (small desktop tester EXtest manufactured by Shimadzu Corporation).

A release liner (length 4 cm x width 4 cm) is placed on an acrylic table in a room with a temperature of 23° C., the compression stress is measured with a cylindrical indenter (made of SUS, indenter area: 100 mm²) pressed in a direction perpendicular to the center of the release liner at a compression rate of 0.1 mm/min, and the compression elastic modulus E (MPa) is calculated according to the following formula.

E(MPa)=(σ2-σ1)/(ε2-ε1)

Compression stress σ1: 0.005 (MPa)

Compression stress σ2: 0.01 (MPa)

Compression strain value ε1: compression strain value at compression stress σ1

Compression strain value ε2: compression strain value at compression stress σ2

The release liner in the present embodiment has a compression elastic modulus of 1.5 MPa or less and is thus excellent in cushioning property. Thus, in the release liner-attached threadlike adhesive of the present embodiment, the threadlike adhesive is stably protected in a state where collapse and falling off are inhibited or prevented. This will be described in detail below.

The part (a) of FIG. 31 is a schematic view illustrating a state where a release liner-attached threadlike adhesive according to one configuration example of the present embodiment is wound in a roll shape (roll-shaped release liner-attached threadlike adhesive). The part (b) of FIG. 31 is a cross-sectional view illustrating a cross-section perpendicular to a winding direction of the roll-shaped release liner-attached threadlike adhesive according to the configuration example. The release liner 12 in the present configuration example has a compression elastic modulus of 1.5 MPa or less and is excellent in cushioning property. Therefore, when the release liner 12 is wound together with the threadlike adhesive 11, the release liner 12 is deformed according to the shape of the threadlike adhesive 11 as shown in the part (b) of FIG. 31. Accordingly, the stress received by the threadlike adhesive 11 from the release liner 12 is alleviated, so that the collapse of the threadlike adhesive 11 is inhibited or prevented and the form as the adhesive body is retained. As shown in the part (b) of FIG. 31, in the release liner-attached threadlike adhesive 10 according to the present configuration example, the threadlike adhesive 11 is sandwiched by the release liner 12 so as to be wrapped around the release liner 12, the threadlike adhesive 11 is unlikely to roll and is unlikely to fall off from the release liner 12. In the example shown in the part (b) of FIG. 31, there are some voids between the threadlike adhesive 11 and the release liner 12, but the present embodiment is not limited to this. There may be no void between the threadlike adhesive 11 and the release liner 12.

The part (a) of FIG. 31 illustrates an example of winding threadlike adhesive 11 so as to be disposed on the inner side, but threadlike adhesive 11 may be wound so as to be disposed on the outer side. As shown in FIG. 32, the release liner-attached threadlike adhesive 10 according to the present embodiment may be wound around the reel 14 or the like.

In the release liner-attached threadlike adhesive according to the present embodiment, similar to the fifth embodiment described later, the release liner is preferably formed with a slit and at least a part of the threadlike adhesive is disposed in the slit. The part (a) of FIG. 33 illustrates a view of a cross-section perpendicular to a longitudinal direction of a release liner 22 formed with a slit 23. The part (b) of FIG. 33 illustrates a view of a cross-section perpendicular to a winding direction of a roll around which a release liner-attached threadlike adhesive 20 including the release liner 22 formed with the slit 23 is wound (a roll-shaped release liner-attached threadlike adhesive 20).

In such a configuration, at least a part of a threadlike adhesive 21 is disposed in the slit 23, and thus, the stress received by the threadlike adhesive 21 from the release liner 22 during the winding is further alleviated, and collapse is more difficult to occur. In addition, the threadlike adhesive 21 is held in the slit 23, and the threadlike adhesive 21 is more unlikely to roll.

A preferred form of the slit 23 is the same as that described in a section of the eight embodiment to be described later.

The material of the release liner in the present embodiment is not limited as long as it has the above compression elastic modulus. From the viewpoint of easily achieving a high cushioning property, the release liner in the present embodiment is preferably a release liner mainly made of a porous material. Here, the expression “a release liner mainly made of a porous material” means that it is a release liner made of only a porous material, or that it is a laminate including a layer made of a porous material and another layer.

Examples of the porous material include the following (1) to (3).

(1) Paper, woven fabric, and non-woven fabric (e.g., polyester (e.g., polyethylene terephthalate (PET)) non-woven fabric).
(2) A material obtained by mechanically perforating a solid film containing one or more resins selected from the group consisting of a polyester (e.g., polyethylene terephthalate (PET)), nylon, Saran (trade name), polyvinyl chloride, polyethylene, polypropylene, an ethylene-vinyl acetate copolymer, polytetrafluoroethylene, and an ionomer.
(3) Foam materials such as polyolefin foams (e.g., a non-cross-linked polyethylene foam, a cross-linked polyethylene foam, a polypropylene foam, and a foam containing polyethylene (PE) and polypropylene (PP) as components), polyester foams (e.g., a polyethylene terephthalate foam), urethane foams (e.g., a soft urethane foam, a hard urethane foam, a urethane-modified a polyisocyanurate foam, and a polyisocyanurate foam), or rubber foams.

Among these, a foam material is preferred, and a polyolefin foam material is more preferred because of good cushioning property.

The porous material preferably has an apparent density of 900 kg/m³ or less, and more preferably 200 kg/m³ or less, as measured in accordance with JIS K 7222 (2005). When the porous material has such an apparent density, the release liner 22 having a particularly excellent cushioning property can be obtained.

On the other hand, from the viewpoint of strength, the apparent density of the porous material is preferably 15 kg/m³ or more, and more preferably 25 kg/m³ or more.

When the porous material is a foam material, an average major axis of micropores is preferably in the range of 10 μm to 1000 μm and an average minor axis of the micropores is preferably in the range of 10 μm to 1000 μm. A porosity in the foam material is preferably 50% to 99%, and more preferably 60% to 98% from the viewpoint of flexibility. Here, the term “porosity” means an area ratio of micropores in an area of the material in a plane perpendicular to a thickness direction of the foam material.

In addition, the release liner may be provided with another layer other than the layer made of a porous material, and examples of another layer include a solid film of metal or resin, a skin layer, and a release layer.

The solid film of metal or resin is a non-perforated film made of a metal or a resin that has not been mechanically perforated, and may be provided to inhibit elongation of the release liner. The inhibition of the elongation of the release liner has advantages such as easy transportation and easy uniform application of a release treatment agent. The “solid film” also includes a metal-made or resin-made film having micropores inevitably generated in the production stage of forming a metal or resin into a film. Examples of the solid film of resin include a film made of one or more resins selected from the group consisting of: polyesters (e.g., polyethylene terephthalate (PET) and polyethylene naphthalate (PEN)); polyamide (e.g., nylon); polyvinyl chloride (PVC); polyvinyl acetate (PVAc); polyvinylidene chloride; polyolefins (e.g., polyethylene (high density polyethylene and low density polyethylene), polypropylene, reactor TPO, an ethylene-propylene copolymer, and an ethylene-vinyl acetate copolymer (EVA)); polyimide (PI); fluorine-based resins (e.g., polytetrafluoroethylene); and cellophane and ionomer resins (e.g., a resin obtained by crosslinking a polymer having a polyethylene unit (E) and an acrylic acid unit (A) with a metal (M)). Examples of the solid film of metal include aluminum foil, copper foil, and stainless steel foil.

The solid film is preferably a solid film of resin, more preferably a film made of one or more resins selected from the group consisting of polyolefins, polyesters, and polyimides, and still more preferably a film made of one or more resins selected from the group consisting of polyethylene (high density polyethylene and low density polyethylene), polypropylene, an ethylene-propylene copolymer, an ethylene-vinyl acetate copolymer, and polyethylene terephthalate.

A thickness of the solid film of metal or resin is preferably 3 μm to 80 μm, more preferably 3 μm to 50 μm, and still more preferably 10 μm to 50 μm, from the viewpoint of maintaining the cushioning property of the release liner and stable formation of a release layer to be described later.

Lamination of a solid film on a layer made of a porous material is performed by a known method for laminating a laminated film, such as hot pressing with a hot press machine or continuous heat laminating with roll-to-roll.

The “skin layer” is a porous thin layer having a porosity smaller than a porosity of the layer made of a porous material, which is formed on the surface of the layer made of a porous material, and may be provided to inhibit the elongation of the release liner. The “porosity” is an area ratio of micropores in the area of the thin layer on a plane perpendicular to the thickness direction of the layer made of a porous material. The porosity of the skin layer is preferably 10% or less, and more preferably 5% or less, from the viewpoint of maintaining the cushioning property of the layer made of a porous material and the stable formation of the release layer to be described later. A thickness of the skin layer is preferably 3 μm to 50 μm, and more preferably 3 μm to 20 μm, from the viewpoint of maintaining the cushioning property of the release liner and the stable formation of the release layer to be described later.

The skin layer is formed, for example, by melting a surface layer portion of the layer made of a porous material. For example, the skin layer can be formed on a contact surface side of the layer made of a porous material with a heating roll, by using the heating roll set to a temperature about 5° C. to 20° C. lower than the melting point of the porous material, and reducing a rotation speed of the heating roll to be lower than a traveling speed of the heating roll on the layer made of a porous material.

The release layer is a layer formed on a contact surface between the release liner and the adhesive body and is difficult to be stuck by the adhesive body, and may be provided to facilitate the debonding between the release liner and the adhesive body. The release layer can be formed, for example, by applying a release treatment agent (release agent) to the surface of the release liner and performing curing.

The release treatment agent (release agent) used for forming the release layer is not limited, but a fluorine-based release agent, a long-chain alkyl acrylate-based release agent, a silicone-based release agent, or the like is used. Among these, a silicone-based release agent is preferred. As a curing method, a curing method such as ultraviolet irradiation or electron beam irradiation is preferably used. Further, among the silicone-based release agent, a cationically polymerizable ultraviolet curable silicone-based release agent is preferred. The cationically polymerizable ultraviolet curable silicone-based release agent is a mixture containing cationically polymerizable silicone (polyorganosiloxane having an epoxy functional group in the molecule) and an onium salt-based photoinitiator, is particularly preferably one in which the onium salt-based photoinitiator is composed of a boron-based photoinitiator. The use of such a cationically polymerizable ultraviolet curable silicone-based release agent in which the onium salt-based photoinitiator is composed of a boron-based photoinitiator allows for particularly good debondability (releasability). The cationically polymerizable silicone (polyorganosiloxane having an epoxy functional group in the molecule) has at least two epoxy functional groups in one molecule and may be linear, branched or a mixture thereof. The type of the epoxy functional group in the polyorganosiloxane is not limited, but may be any one in which ring-opening cationic polymerization proceeds by using an onium salt-based photoinitiator. Specific examples thereof include a γ-glysidyloxypropyl group, a β-(3,4-epoxycyclohexyl)ethyl group, and a β-(4-methyl-3,4 epoxycyclohexyl)propyl group. Such cationically polymerizable silicone (polyorganosiloxane having an epoxy functional group in the molecule) is available on the market, and commercially available products can be used. Examples of the cationically polymerizable silicone include UV9315, UV9430, UV9300, TPR6500, and TPR6501 manufactured by Toshiba Silicone Co., Ltd., X-62-7622, X-62-7629, X-62-7655, X-62-7660, and X-62-7634A manufactured by Shin-Etsu Chemical Co., Ltd., and Poly200, Poly201, RCA200, RCA250, and RCA251 manufactured by Arakawa Chemical Industries, Ltd.

In addition, as the silicone-based release agent, a thermosetting addition-type silicone-based release agent (thermosetting addition-type polysiloxane-based release agent) can also be used. The thermosetting addition-type silicone-based release agent contains a polyorganosiloxane (silicone having an alkenyl group) having an alkenyl group as a functional group in the molecule and a polyorganosiloxane having a hydrosilyl group as a functional group in the molecule, as essential constituents.

For the polyorganosiloxane having an alkenyl group as a functional group in the molecule, a polyorganosiloxane having two or more alkenyl groups in the molecule is preferred. Examples of the alkenyl group include a vinyl group (ethenyl group), an allyl group (2-propenyl group), a butenyl group, a pentenyl group, and a hexenyl group. The above alkenyl group typically bonds to a silicon atom of polyorganosiloxane forming a main chain or a skeleton (for example, a silicon atom at the terminal or a silicon atom inside the main chain).

Examples of the polyorganosiloxane forming a main chain or a skeleton include polyalkylalkylsiloxanes (polydialkylsiloxanes) such as polydimethylsiloxane, polydiethylsiloxane, and polymethylethylsiloxane, polyalkylarylsiloxanes, and a copolymer in which multiple types of silicon atom-containing monomer components are used (e.g., poly(dimethylsiloxane-diethylsiloxane)). Among these, polydimethylsiloxane is preferred. That is, as the polyorganosiloxane having an alkenyl group as a functional group in the molecule, specifically, polydimethylsiloxane having a vinyl group, a hexenyl group or the like as a functional group is preferably exemplified.

The above polyorganosiloxane crosslinking agent having a hydrosilyl group as a functional group in the molecule is a polyorganosiloxane having a hydrogen atom bonding to a silicon atom (particularly a silicon atom having a Si—H bond) in the molecule, and is preferably a polyorganosiloxane having two or more silicon atoms having a Si—H bond in the molecule. The above silicon atom having a Si—H bond may be either a silicon atom in the main chain or a silicon atom in the side chain, that is, may be included as a constituent unit of the main chain, or may be included as a constituent unit of the side chain. The number of silicon atoms in the Si—H bond is not limited as long as it is two or more. As the above polyorganosiloxane crosslinking agent having a hydrosilyl group as a functional group in the molecule, specifically, polymethylhydrogensiloxane, poly(dimethylsiloxane-methylhydrogensiloxane) and the like are preferred.

For a thermosetting silicone-based release treatment agent, a reaction inhibitor (reaction retarder) may be used together with the thermosetting silicone-based resin, in order to impart storage stability at room temperature. When a thermosetting addition-type silicone-based release agent is used as the release agent, examples of the reaction inhibitor include 3,5-dimethyl-1-hexyne-3-ol, 3-methyl-1-pentene-3-ol, 3-methyl-3-pentene-1-yne, and 3,5-dimethyl-3-hexene-1-yne.

In addition, in the thermosetting silicone-based release treatment agent, a release control agent or the like may be used, if necessary, in addition to the above components. Specifically, a release control agent such as MQ resin, polyorganosiloxane having no alkenyl group or hydrosilyl group (trimethylsiloxy group-terminated blocking polydimethylsiloxane, etc.) and the like may be added. The content of these components in the release treatment agent is not limited, and is preferably 1 mass % to 30 mass % with respect to the total solid content.

The thermosetting silicone-based release treatment agent typically contains a curing catalyst. As the curing catalyst, a platinum-based catalyst typically used as a catalyst for thermosetting addition-type silicone is preferably used. Among these, at least one platinum-based catalyst selected from chloroplatinic acid, a platinum olefin complex, and a chloroplatinic acid olefin complex is preferred. The curing catalyst can be used as it is or in a form dissolved or dispersed in a solvent.

The blending amount (solid content) of the curing catalyst is preferably 0.05 to 0.55 parts by mass, and more preferably 0.06 to 0.50 parts by mass with respect to 100 parts by mass (resin content) of the thermosetting silicone-based resin. When the blending amount of the curing catalyst is less than 0.05 parts by mass, the curing rate is slow, and when the blending amount is more than 0.55 parts by mass, the pot life is greatly shortened.

An organic solvent is typically used in a coating solution containing the release treatment agent to be used for providing the release layer in order to improve the coatability. The organic solvent is not limited, but for example, aliphatic or alicyclic hydrocarbon solvents such as cyclohexane, hexane, and heptane, aromatic hydrocarbon solvents such as toluene and xylene, ester solvents such as ethyl acetate and methyl acetate, ketone solvents such as acetone and methyl ethyl ketone, and alcoholic solvents such as methanol, ethanol and butanol can be used. The organic solvent may be used alone or in combination of two or more kinds thereof.

A thickness of the release layer is preferably 0.001 μm to 10 μm, more preferably 0.03 μm to 5 μm, and particularly preferably 0.1 μm to 1 μm from the viewpoint of excellent debondability (releasability) and inhibition of a thickness unevenness (stable formation of the release layer).

As the release liner in the present embodiment, a film subjected to an unevenness treatment can also be preferably used.

Here, a surface roughness (Ra) of the film subjected to the unevenness treatment is preferably 0.05 μm or more, and more preferably 0.07 μm or more, from the viewpoint of a shape retention property of the threadlike adhesive. In addition, the surface roughness (Ra) is preferably 50 μm or less, and more preferably 30 μm or less, as the threadlike adhesive tends to be moved easily during storage. The definition of the surface roughness (Ra) of the film subjected to the unevenness treatment is based on JIS B 0601 (1994 version). The surface roughness (Ra) of the film subjected to the unevenness treatment can be measured by a stylus type surface roughness measuring instrument (for example, high-precision fine shape measuring instrument, product name “Surfcorder ET4000” manufactured by Kosaka Laboratory Ltd.) based on JIS B 0601 (1994 version).

Examples of an unevenness treatment method include embossing and blasting. A temporary support may be coated with a composition containing a binder resin and particles and then the composition is cured to form an uneven surface in the temporary support. In addition, a known method can be used, and for example, screen printing, gravure printing, or transfer by nanoimprint may be used. Among these, embossing is particularly preferred as the embossing may easily achieve the desired debondability.

The material of the film to be subjected to the unevenness treatment is not limited as long as it satisfies the above compression elastic modulus, and may be appropriately selected depending on the desired debondability, hardness and the like.

For example, paper, a resin film, a metal foil, or the like that has been subjected to the unevenness treatment can be used.

As a resin forming the film, for example, a polyester resin, a polyolefin resin, a polyamide resin, a polyimide resin, a polyphenylene sulfide resin, a polycarbonate resin, a polyurethane resin, an ethylene-vinyl acetate resin, a fluorine-based resin such as polytetrafluoroethylene, and an acrylic resin such as polymethyl methacrylate can be used. The resin film may be formed by using a resin material containing one kind of such a resin alone, or may be formed by using a resin material in which two or more kinds are blended. Further, the resin film may be unstretched or stretched (uniaxially stretched or biaxially stretched).

The film subjected to the unevenness treatment can be subjected to a release treatment, if necessary. The release treatment is the same as the release treatment applied to the above release liner mainly composed of a porous material.

The thickness of the release liner in the present embodiment is not limited as long as it has the above compression elastic modulus, but is preferably 10 μm or more, and more preferably 20 μm or more, from the viewpoint of handleability. The upper limit of the thickness of the release liner in the present embodiment is not limited, but may be, for example, 10,000 μm or less. From the viewpoint of cost, the upper limit of the thickness is preferably 1,000 μm or less, and more preferably 700 μm or less.

The cross-sectional shape of the threadlike adhesive in the present embodiment is a circle in the part (b) of FIG. 31, but the shape is not limited to this, and the shape may be various shapes such as an ellipse, a rectangle such as a quadrangle, and the like, other than the circle.

A thickness of the threadlike adhesive in the present embodiment is not limited, and a thickness suitable for the intended use can be selected, but is typically about 0.01 mm to 3 mm.

In addition, a length of the threadlike adhesive in the present embodiment is not limited, and a length suitable for the intended use can be selected.

The threadlike adhesive in the present embodiment may include a core material and a layer (adhesive layer) made of an adhesive that covers the core material. The threadlike adhesive may not include a core material and may consist only of an adhesive. As the adhesive and the core material constituting the threadlike adhesive in the present embodiment, those described with reference to FIG. 20 can be used.

The threadlike adhesive is thinner than other linear members such as a cable and is easily deformed, the release liner is preferably easily deformed even under a low stress such as a compression stress of 0.01 MPa. Therefore, the compression strain value ε2 at the compression stress σ2 of 0.01 MPa is preferably 0.01 or more, and more preferably 0.02 or more.

In the present embodiment, in the threadlike adhesive including a core material and an adhesive layer, an adhesion amount of the adhesive (weight of the adhesive layer per unit length) is not limited and may be appropriately determined according to the type of member to be stuck and the intended use. From the viewpoint of adhesiveness, for example, the adhesion amount of the adhesive is preferably 2 mg/m or more, more preferably 5 mg/m or more, and still more preferably 8 mg/m or more. On the other hand, when the adhesion amount of the adhesive is excessive, it is necessary to apply the adhesive to the core material a plurality of times in the production process, or it takes time to dry the applied adhesive, resulting in a low production efficiency. Therefore, the adhesion amount of the adhesive is preferably 200 mg/m or less, more preferably 180 mg/m or less, and still more preferably 160 mg/m or less.

A thickness of the core material is not limited, and may be appropriately determined according to the type of member to be stuck and the intended use, but is for example, about 20 dtex to 2,000 dtex.

The threadlike adhesive not including a core material can be obtained, for example, by preparing an adhesive, applying the adhesive linearly on the release liner using a dispenser, and performing heating and drying if necessary.

The threadlike adhesive including a core material can be obtained by coating the core material with an adhesive by using known coaters such as a gravure roll coater, a reverse roll coater, a kiss roll coater, a dip roll coater, a bar coater, a knife coater, and a spray coater, and performing heating and drying as necessary.

### Eighth Embodiment

A release liner-attached threadlike adhesive 30 according to the eighth embodiment of the present invention includes a threadlike adhesive 31 and a release liner 32, the release liner 32 is formed with a slit 33, and at least a part of the threadlike adhesive 31 is disposed in the slit 33.

The part (a) of FIG. 34 illustrates a view of a cross-section perpendicular to a longitudinal direction of the release liner-attached threadlike adhesive 30 according to the present embodiment. The part (b) of FIG. 34 illustrates a view of a cross-section perpendicular to a winding direction of a roll around which the release liner-attached threadlike adhesive 30 according to the present embodiment is wound (a roll-shaped release liner-attached threadlike adhesive 30).

In the release liner-attached threadlike adhesive 30 according to the present embodiment, at least a part of the threadlike adhesive 31 is disposed in the slit 33, and thus the threadlike adhesive 31 is less likely to receive a pressure from the release liner 32 and is less likely to be collapsed even in the case of winding. In addition, in the present embodiment, at least a part of the threadlike adhesive 31 is disposed in the slit 33, and the threadlike adhesive 31 is difficult to fall off.

The shape, width, depth, etc. of the slit in the present embodiment are not limited as long as at least a part of the threadlike adhesive can be disposed in the slit. When the release liner-attached threadlike adhesive is wound as shown in FIG. 29, the slit may be provided along a path in which the threadlike adhesive 2 is disposed on the release liner SP.

In order to further reduce the pressure applied to the threadlike adhesive from the release liner and make the threadlike adhesive more difficult to collapse, the shape, width, depth, etc. of the slit are preferably configured such that the entire threadlike adhesive can be disposed in the slit. That is, the slit 33 in the present embodiment is preferably in a state that, in the view of the cross-section perpendicular to the longitudinal direction of the threadlike adhesive 31 in a disposed state (not in a wound state), the threadlike adhesive 31 does not protrude from a surface 32a on the side where the slit 33 of the release liner 32 is formed, as in the configuration example shown in the part (a) of FIG. 34 and the part (b) of FIG. 34. Examples of the cross-sectional shape of such a slit include a V-shape, a U-shape, an arc shape, and a concave shape.

For example, in the configuration example shown in the part (a) of FIG. 34, the cross-sectional shape of the slit 33 is a V-shape, and in the configuration example shown in the part (a) of FIG. 35, the cross-sectional shape of a slit 43 is a concave shape. In the configuration example shown in the part (a) of FIG. 35 and the part (b) of FIG. 35, a release liner-attached threadlike adhesive 40 is also preferably configured such that a threadlike adhesive 41 does not protrude from a surface 42a on the side where a slit 43 of a release liner 42 is formed.

The cross-sectional shape of the slit is not limited to a straight line or a curved line, and may be formed in a zigzag line or a wavy line.

On the other hand, from the viewpoint of productivity, the slit is preferably a simple notch as shown in the part (a) of FIG. 33, for example.

In the present embodiment, the number of slits formed in the release liner is not limited, but may be one or two or more. Further, the slit may be formed in only one side of the release liner, or may be formed on both sides.

The compression elastic modulus of the release liner in this embodiment is not limited. In order to further alleviate the stress received by the threadlike adhesive from the release liner and to make the threadlike adhesive more difficult to collapse, the release liner preferably has a high cushioning property also in the present embodiment. From this viewpoint, the release liner in the present embodiment also preferably has a compression elastic modulus of 1.5 MPa or less, similar to the fourth embodiment.

In addition, the material of the release liner in the present embodiment is also not limited. From the viewpoint of easily achieving a high cushioning property, the release liner in the present embodiment is preferably a release liner mainly made of a porous material, similar to the fourth embodiment. As the porous material, for example, those exemplified in the section of the fourth embodiment can be used.

The release liner in the present embodiment may include a solid film of metal or resin, a skin layer, and a release layer, similar to the release liner in the fifth embodiment. The threadlike adhesive in the present embodiment is not limited, but the threadlike adhesive same as that described in the section of the fifth embodiment can be used.

In the use of the release liner-attached threadlike adhesive according to the above embodiments, for example, the threadlike adhesive can be debonded from the release liner and stuck to an adherend. Alternatively, the release liner-attached threadlike adhesive can be stuck to an adherend for each release liner and then the release liner can be debonded, that is, the threadlike adhesive can be transferred to the adherend.

Hereinafter, a method for transferring the threadlike adhesive 2 stuck to the release liner to the adherend will be described. First, the threadlike adhesive 2 is stuck to the release liner by the threadlike adhesive sticking apparatus and the method for sticking a threadlike adhesive of the present embodiment described above. In order to stuck the threadlike adhesive 2 to the adherend in a desired shape, the threadlike adhesive 2 is stuck (drawn) on the release liner in a shape obtained by inverting the desired shape.

Next, the adhesive surface of the threadlike adhesive 2 stuck to the release liner is brought into contact with the adherend, and the threadlike adhesive 2 is pressed and allowed to bond to the adherend through the release liner by a roller, a finger, or the like.

Thereafter, the release liner is debonded and removed from the threadlike adhesive 2 stuck to the adherend to expose the threadlike adhesive 2. In this way, the threadlike adhesive 2 is stuck to the adherend in a desired shape.

In order to reliably transfer the threadlike adhesive, that is, in order to prevent the threadlike adhesive from being debonded from the adherend and remaining on the release liner, the release liner is preferable debonded from the adherend by peeling, and a peeling angle at this time is preferably 5′ or more, more preferably 10° or more, and still more preferably 20° or more. When the release liner is debonded from the adherend by peeling, the release liner may be debonded with the release liner deformed, the release liner may be debonded with the adherend deformed, or the release liner may be debonded with both the release liner and the adherend deformed. A suitable peeling method may be appropriately selected according to the hardness (deformability) of the release liner and the adherend.

As described above, the threadlike adhesive 2 is formed (drawn) on the release liner into a shape obtained by inverting a desired shape and then transferred to stick the threadlike adhesive 2 to the adherend in a desired shape. Accordingly, the threadlike adhesive 2 can be easily stuck to the adherend even when the sticking shape is complicated.

Based on such a feature, the method of sticking the threadlike adhesive by transfer is suitable as, for example, a method of sticking the threadlike adhesive body for fixing a cable such as an electric wire or an optical fiber, a LED fiber light, optical fiber sensors such as fiber Bragg gratings (FBG), various wires (linear members) such as a yarn, a string, or a wire, or a narrow member in a desired form. Even in the case of fixing a wire or a narrow member to another member having a complicated shape, with the method of sticking the threadlike adhesive by transfer, the threadlike adhesive can be easily stuck to a member to which a wire or a narrow member is stuck according to a complicated shape of the wire or the narrow member.

For example, the use of the threadlike adhesive for temporary fixing in sewing fiber products or leather products such as clothes, shoes, bags, or hats allows for avoiding a part to be sewed and facilitates the temporarily fixing of the threadlike adhesive. And, the use allows for easily preventing the adhesive from adhering to the needle. When an article to be sewn has a complicated shape or is easily deformed, it is not sometimes easy to stick the threadlike adhesive. However, even in such a case, the threadlike adhesive can be easily stuck by the method of sticking the threadlike adhesive by transfer.

### EXAMPLE

Hereinafter, the seventh and eighth embodiments of the present invention will be described in detail with reference to Examples, but the present invention is not limited to these Examples.

### (Preparation of Adhesive)

Into a reaction vessel equipped with a cooling tube, a nitrogen introduction tube, a thermometer, and a stirrer, 40 parts by mass of ion-exchanged water was added, and stirring was performed at 60° C. for 1 hour or more while introducing nitrogen gas to carry out nitrogen substitution. To this reaction vessel, 0.1 parts by mass of 2,2′-azobis[N-(2-carboxyethyl)-2-methylpropionamidine]n hydrate (polymerization initiator) was added. While the system was maintained at 60° C., a monomer emulsion A was gradually added dropwise thereto over 4 hours to proceed with an emulsion polymerization reaction.

Examples of the monomer emulsion A include an emulsion obtained by adding 98 parts by mass of 2-ethylhexyl acrylate, 1.25 parts by mass of acrylic acid, 0.75 parts by mass of methacrylic acid, 0.05 parts by mass of lauryl mercaptan (chain transfer agent), 0.02 parts by mass of γ-methacryloxypropyltrimethoxysilane (manufactured by Shin-Etsu Chemical Co., Ltd., trade name: “KBM-503”), and 2 parts by mass of sodium polyoxyethylene lauryl sulfate (emulsifier) to 30 parts by mass of ion-exchanged water and by emulsifying the mixture. After completion of the dropwise addition of the monomer emulsion A, the system was further kept at 60° C. for 3 hours and then cooled to room temperature, and pH of the system was then adjusted to 7 by addition of 10% ammonia water to obtain an acrylic polymer emulsion (water-dispersible acrylic polymer).

A tackifying resin emulsion (trade name: “E-865NT”, manufactured by Arakawa Chemical Industries, Ltd.) was added in an amount of 20 parts by mass based on the solid content per 100 parts by mass of the acrylic polymer contained in the above acrylic polymer emulsion. Further, the pH was adjusted to 7.2 and the viscosity was adjusted to 10 Pa·s using 10 mass % ammonia water as a pH adjuster and polyacrylic acid (trade name: “ARON B-500”, manufactured by Toagosei Co., Ltd.) as a thickener. Accordingly, a water-dispersible acrylic adhesive was obtained.

### (Preparation of Threadlike Adhesive)

A multifilament yarn (280 dtex) obtained by twisting 48 polyester yarns (filaments) at 150 times/m was used as a core material. The core material was coated with the water-dispersible acrylic adhesive obtained above by dipping such that the adhesion amount of the adhesive in the obtained adhesive body was 22 mg/m, and then dried at 80° C. for 5 minutes to form an adhesive layer, thereby obtaining an adhesive body (threadlike adhesive).

### Example 1

As the release liner, a polyethylene foam base material (PE, manufactured by Nitto Denko Corporation) having a length of 4 cm, a width of 4 cm, and a thickness of 0.5 mm was prepared. From one side to the opposite side of the release liner, a threadlike adhesive having a length of 4 cm prepared as described above was stuck to obtain a release liner-attached threadlike adhesive in Example 1.

### Example 2

A release liner-attached threadlike adhesive in Example 2 was obtained in the same manner as in Example 1, except that an embossed polyurethane film (surface roughness Ra: 0.2 μm) having a length of 4 cm, a width of 4 cm, and a thickness of 0.3 mm was used as the release liner.

### Example 3

A release liner-attached threadlike adhesive in Example 3 was obtained in the same manner as in Example 1, except that foamed polyethylene P1005 (manufactured by Fuji Gomu Co., Ltd.) having a length of 4 cm, a width of 4 cm, and a thickness of 10 nam was used as the release liner.

### Example 4

A release liner-attached threadlike adhesive in Example 3 was obtained in the same manner as in Example 1, except that rubber sponge NR33 (manufactured by Inoac Corporation) having a length of 4 cm, a width of 4 cm, and a thickness of 5 mm was used as the release liner.

### Example 5

As the release liner, a polyethylene terephthalate (PET) film having a length of 4 cm, a width of 5 cm, and a thickness of 0.5 mm was prepared. The 5 cm side to the opposite 5 cm side of this release liner was subjected to carve a line with TAMIYA CRAFT TOOLS FINEENGRAVING BLADE (line carving super hard blade, 0.4 mm, manufactured by Tamiya Inc.) to form a concave slit (as shown in the part (a) of FIG. 35) having a depth of 0.2 mm and a width of 0.4 mm. In the formed slit, a threadlike adhesive body having a length of 4 cm prepared as described above was disposed to obtain a release liner-attached threadlike adhesive in Example 5.

### Example 6

A release liner-attached threadlike adhesive in Example 6 was obtained in the same manner as in Example 5, except that the slit was changed to a V-shaped slit (as shown in the part (a) of FIG. 34) having a depth of 0.4 mm and a width of 0.4 mm. The V-shaped slit was formed by applying a 5 cm razor blade diagonally to the surface of the release liner from the side having 5 cm long to the opposite side having 5 cm long of the release liner and gradually hitting a hammer.

### Example 7

A release liner-attached threadlike adhesive in Example 7 was obtained in the same manner as in Example 5, except that the slit was changed to a V-shaped slit (as shown in the part (a) of FIG. 34) having a depth of 0.2 mm and a width of 0.4 mm.

The V-shaped slit was formed by applying a 5 cm razor blade diagonally to the surface of the release liner from the side having 5 cm long to the opposite side having 5 cm long of the release liner and gradually hitting a hammer.

### Example 8

A release liner-attached threadlike adhesive in Example 8 was obtained in the same manner as in Example 5, except that a polyethylene foam base material (manufactured by Nitto Denko Corporation) having a length of 4 cm, a width of 5 cm, and a thickness of 0.5 mm was used as the release liner.

### Example 9

As the release liner, a polyethylene foam base material (manufactured by Nitto Denko Corporation) having a length of 4 cm, a width of 5 cm, and a thickness of 0.5 mm was prepared. From one side to the opposite side of this release liner, a notched slit as shown in the part (a) of FIG. 33 having a depth of 0.2 mm was formed. In the formed slit, the threadlike adhesive body having a length of 4 cm prepared as described above was disposed to obtain a release liner-attached threadlike adhesive in Example 9.

The notched slit was formed by applying a 5 cm razor blade vertically to the surface of the release liner from the side having 5 cm long to the opposite side having 5 cm long of the release liner and gradually hitting a hammer.

### Comparative Example 1

A release liner-attached threadlike adhesive in Comparative Example 1 was obtained in the same manner as in Example 1, except that a polyethylene terephthalate (PET) film having a length of 4 cm, a width of 4 cm, and a thickness of 0.5 mm was used as the release liner.

### (Compression Elastic Modulus)

The compression elastic modulus of the release liner was measured by the following compression test using an autograph (small desktop tester EXtest manufactured by Shimadzu Corporation). The results are shown in Table 1.

A release liner (length 4 cm x width 4 cm) used in each of Examples was placed on an acrylic table in a room with a temperature of 23° C., the compression stress was measured while pressing a cylindrical indenter (made of SUS, indenter area: 100 mm²) in a direction perpendicular to the center of the release liner at a compression rate of 0.1 mm/min, and the compression elastic modulus E (MPa) was calculated according to the following equation.

E(MPa)=(σ2−σ1)/(ε2−ε1)

Compression stress σ1: 0.005 (MPa)

Compression stress σ2: 0.01 (MPa)

Compression strain value ε1: compression strain value at compression stress σ1

Compression strain value ε2: compression strain value at compression stress σ2

(Shape Retention Property of Threadlike adhesive)

The release liner-attached threadlike adhesive prepared in each of Examples was placed on a first acrylic plate having a length of 4 cm and a width of 4 cm such that the surface of the release liner-attached threadlike adhesive on the side having the adhesive faces downward, and then a second acrylic plate is placed thereon (first acrylic plate/threadlike adhesive/release liner/second acrylic plate). A load of 2 kg was applied from above for 20 minutes, and it was visually confirmed whether the shape of the threadlike adhesive was retained after unloading according to the following evaluation criteria. The results are shown in Tables 1 and 2.

A: the shape same as the shape before the load is applied is retained.

B: the shape is almost the same as the shape before the load is applied.

C: the threadlike adhesive is collapsed and spreads laterally, but the shape of the threadlike adhesive is retained.

D: the threadlike adhesive is collapsed and spreads sideways, and the shape of the threadlike adhesive cannot be retained.

TABLE 1

| | ε1 | ε2 | | Shape retention |
|---|---|---|---|---|
| | σ1: 0.005 | σ2: 0.01 | E (MPa) = (σ2 − | property of |
| | (MPa) | (MPa) | σ1)/(ε2 − ε1) | adhesive body |
| Example 1 | 0.104 | 0.162 | 0.09 | B |
| Example 2 | 0.028 | 0.038 | 0.50 | B (adhesive |
| | | | | on embossed |
| | | | | surface) |
| Example 3 | 0.016 | 0.021 | 0.96 | B |
| Example 4 | 0.008 | 0.012 | 1.25 | C |
| Comparative | 0.014 | 0.017 | 1.92 | D |
| Example 1 | | | | |

As shown in Table 1, in the release liner-attached threadlike adhesives in Examples 1 to 4 in which the compression elastic modulus of the release liner was 1.5 MPa or less, the collapsing of the threadlike adhesive was inhibited or prevented and the shape of the adhesive body was retained even after the load was applied. On the other hand, in the release liner-attached adhesive body in Comparative Example 1 in which the compression elastic modulus of the release liner was more than 1.5 MPa, the threadlike adhesive was collapsed and the shape of the threadlike adhesive could not be retained after the load was applied.

TABLE 2

| | | | | | | Shape |
|---|---|---|---|---|---|---|
| | Release liner | | ε1 | ε2 | | retention |
| | Type | | σ1: 0.005 | σ2: 0.01 | E (MPa) = (σ2 − σ1)/ | property of |
| | (thickness) | Slit shape | (MPa) | (MPa) | (ε2 − ε1) | adhesive body |
| Example 5 | PET | Concave shape | 0.014 | 0.017 | 1.92 | B |
| | (0.5 mm) | depth 0.2 mm | | | | |
| | | width 0.4 mm | | | | |
| Example 6 | PET | V-shape | 0.014 | 0.017 | 1.92 | B |
| | (0.5 mm) | depth 0.4 mm | | | | |
| | | width 0.4 mm | | | | |
| Example 7 | PET | V-shape | 0.014 | 0.017 | 1.92 | C |
| | (0.5 mm) | depth 0.4 mm | | | | |
| | | width 0.4 mm | | | | |
| Example 8 | PE | Concave shape | 0.104 | 0.162 | 0.09 | A |
| | (0.5 mm) | depth 0.2 mm | | | | |
| | | width 0.4 mm | | | | |
| Example 9 | PE | Notch shape | 0.104 | 0.162 | 0.09 | B |
| | (0.5 mm) | depth 0.2 mm | | | | |

As shown in Table 2, in the release liner-attached threadlike adhesives in Examples 5 to 9 in which the release liner was formed with a slit and the threadlike adhesive was disposed in the slit, the collapsing of the adhesive body was inhibited or prevented and the shape of the threadlike adhesive was retained even after the load was applied.

Even in the release liner-attached threadlike adhesives in Examples 5 to 7 in which the compression elastic modulus of the release liner was more than 1.5 MPa, the slit formed in the release liner prevented the threadlike adhesive from being deformed and collapsed. In Example 7 in which the slit was shallower than that of Example 6, the threadlike adhesive was collapsed and spreads laterally, but the shape of the threadlike adhesive was retained.

In Example 8 in which the compression elastic modulus of the release liner was 1.5 MPa or less, deformation of the threadlike adhesive was not observed. In addition, in Example 9, the shape was almost the same as the shape before the load was applied.

The release liner-attached threadlike adhesives of the seventh and eighth embodiments of the present invention described above allows for preventing or inhibiting collapse and falling off of the threadlike adhesive and allows for protecting the threadlike adhesive. Thus, the release liner-attached threadlike adhesives of the seventh and eighth embodiments of the present invention described above is preferable. In addition, the release liner-attached threadlike adhesive of the present invention allows for preventing or inhibiting collapse and falling off of even a threadlike adhesive having a high adhesive force and allows for protecting the threadlike adhesive.

The threadlike adhesives 2 of the first to eighth embodiments described above have flexibility and can be bent in various directions and angles like yarns. According to the threadlike adhesive having flexibility, in addition to the above-described effects, there is an advantage that the threadlike adhesive is easily applied to complicated shapes such as a curve, a curved surface, and unevenness.

For example, when an adhesive tape is stuck to an adherend having a part with a complicated shape such as a curved line, a curved surface, or an uneven shape, a wrinkle or overlapping may occur in the adhesive tape in such a part, and this makes it difficult to finely stick the adhesive tape and to prevent a protrusion. The part where a wrinkle or overlapping occurs may cause a decrease in the adhesive force. In order to prevent the occurrence of a wrinkle or overlapping and to stick the adhesive tape, the adhesive tape may be stuck while finely cutting the adhesive tape. However, this significantly deteriorates workability. On the other hand, an adhesive body having flexibility, in particular, a threadlike adhesive body can be firmly stuck without causing a wrinkle or overlapping even when the threadlike adhesive body is stuck to a part having a complicated shape such as a curved line, a curved surface, and an uneven shape. Further, such an adhesive body can be stuck to a part to be stuck at one time, that is, in one step, and thus, the adhesive body is excellent in workability and can be applied to an automation line.

Specific examples of an application of the threadlike adhesive body include an application to fix cables such as electric wires or optical fibers, optical fiber sensors such as LED fiber light and Fiber Bragg Gratings (FBG), various wire members (linear members) such as a yarn, a string, and a wire, and a narrow member, in a desired form. For example, even when a wire member or a narrow member is fixed to another member in a complicated shape, the threadlike adhesive body can be firmly fixed with excellent workability while preventing protrusion, wrinkles, and overlapping in accordance with the complicated shape of the wire member or the narrow member. When the wire member or the narrow member is fixed to another member, the threadlike adhesive body is stuck in advance in accordance with a form in which the wire member or the narrow member is to be fixed on a surface of the other member, and then, the wire member or the narrow member can be allowed to bond and fixed in accordance with the adhesive body stuck to the surface of another member. Alternatively, the threadlike adhesive body is stuck to a wire member or a narrow member, and then, the wire member or the narrow member may be fixed to another member in a desired form.

The threadlike adhesive body can also be suitably used for temporary fixing (temporary tacking) of an article, for temporarily fixing (temporarily tacking) one article to a surface of another article. More specifically, the threadlike adhesive body can be particularly suitably used for temporary fixing (temporary tacking) in producing, for example, fiber products and leather products such as clothes, shoes, bags, and hats. However, the application is not limited to this example, and the threadlike adhesive body is suitably used for various applications in which temporary fixing (temporary tacking) is desired.

For example, when one article is fixed to a surface of another article, the one article is temporarily fixed and positioned on the surface of another article in advance using the threadlike adhesive body, and then both articles are fixed (finally fixed) by a fixing method such as thermocompression bonding and sewing. In this case, the threadlike adhesive body easily and temporarily fixes the two articles without a fixing unit provided between the two articles. For example, in the case that a fiber product or a leather product is sewn, when temporary fixing is performed using the threadlike adhesive body, the temporary fixing can be easily performed, avoiding a part to be sewed, and the adhesive can be easily prevented from adhering to a needle.

In addition, the threadlike adhesive body can be well stuck with a protrusion, a wrinkle, and overlapping prevented even when shapes of two articles are a complicated shape such as a curved line, a curved surface, and an uneven shape. Further, the threadlike adhesive body can be stuck in one step, and workability is sufficient.

Even in the case of a member that is likely to be deformed, such as fabric, cloth, and leather, which forms a fiber product or a leather product, temporary fixing with the threadlike adhesive body allows for preventing deformation of the member due to tension to improve a design after fixing (final fixing).

Further, after two articles are fixed (finally fixed) using the threadlike adhesive body, the threadlike adhesive body can also be pulled out and removed if necessary from the two articles that are fixed (finally fixed). In this case, the adhesive can be prevented from protruding and from deterioration of a design due to aging discoloration of the remaining adhesive satisfactorily.

Furthermore, the threadlike adhesive body can be twisted with a yarn made of other material to form a composite yarn or can be woven with a yarn or cloth (including nonwoven fabric and sheet) made of other material to seek a function combination.

The present invention is not limited to the above embodiment, and may be appropriately modified, improved or the like. Materials, shapes, sizes, numerical values, forms, numbers, arrangement positions, and the like of components in the embodiments described above are set as desired and are not limited as long as the present invention can be achieved.

### INDUSTRIAL APPLICABILITY

The threadlike adhesive sticking apparatus and the method for sticking a threadlike adhesive allow for inhibiting or preventing collapse and falling off of the release liner-attached threadlike adhesive, and allows for a smoothly sticking of the threadlike adhesive without lowering sticking accuracy. Therefore, the present invention can be applied to bonding work in various fields.

Although preferred embodiments of the present invention have been described above, the present invention is not limited to the above embodiments, and various modifications and substitutions can be added to the above embodiments without departing from the scope of the present invention.

The present application is based on a Japanese patent application (No. 2020-064050) filed on Mar. 31, 2020, contents of which are incorporated herein by reference.

### REFERENCE SIGNS LIST

1 Main body
2, 11, 21, 31, 41 Threadlike adhesive
3 Grip
4 Tip end portion
5, 120 Winding body
10, 20, 30, 40 Release liner-attached threadlike adhesive
12, 22, 32, SP, 42 Release liner
14 Reel
23, 33, 43 Slit
100, 101, 101A, 101B, 200, 200A, 200B Threadlike adhesive sticking apparatus
105 Horizontal moving unit
106, 201 Attachment plate
106a Roller attachment portion
106b Nozzle attachment portion
107 Nozzle
107d Tip end
136, 137, 215 Spring
150A to 150E Feeding-out assist mechanism
AU Supply unit
BU Pressing mechanism
CU Conveyance unit
DU Positioning unit

1. A threadlike adhesive sticking apparatus comprising:
a pressing unit configured to press a threadlike adhesive debonded from a release liner against an object,
wherein a compression elastic modulus of the release liner is 1.5 MPa or less, and
wherein the threadlike adhesive sticking apparatus is configured to press the threadlike adhesive wound in a roll shape together with the release liner against the object while the threadlike adhesive is fed out.

2. The threadlike adhesive sticking apparatus according to claim 1, wherein the release liner comprises a slit, and at least a part of the threadlike adhesive is disposed in the slit.

3. A threadlike adhesive sticking apparatus comprising:
a pressing unit configured to press a threadlike adhesive debonded from a release liner against an object, wherein
wherein the release liner comprises a slit, and at least a part of the threadlike adhesive is disposed in the slit, and
wherein the threadlike adhesive sticking apparatus is configured to press the threadlike adhesive wound in a roll shape together with the release liner against the object while the threadlike adhesive is fed out.

4. The threadlike adhesive sticking apparatus according to claim 2, wherein the slit is formed along a path in which the threadlike adhesive is disposed on the release liner.

5. The threadlike adhesive sticking apparatus according to claim 1, wherein the threadlike adhesive is traverse-wound around a reel over a width of a predetermined length via the release liner, and the release liner is a sheet having a size having at least the predetermined width and a length of at least an outer circumference of the reel.

6. The threadlike adhesive sticking apparatus according to claim 1, further comprising:
a nozzle comprising an inner wall surface defining a cylindrical internal space and comprising a tip end having a tip end opening at one end of the inner wall surface, the tip end opening allowing the internal space to communicate with the outside,
wherein the pressing unit is configured to press the threadlike adhesive allowed to pass through the internal space and is led out to the outside from the tip end opening, against the object, and
portions of a peripheral portion surrounding the tip end opening at the tip end function as the pressing unit.

7. The threadlike adhesive sticking apparatus according to claim 1, further comprising:
an assist mechanism configured to apply an external force in a feeding direction to the threadlike adhesive wound together with the release liner,
wherein the pressing unit is configured to press the fed out threadlike adhesive debonded from the release liner against the object.

8. The threadlike adhesive sticking apparatus according to claim 1, further comprising:
a displacement unit attached to the pressing unit and configured to displace the pressing unit by being displaced in a pressing direction; and
an absorption mechanism configured to absorb a displacement of the pressing unit with respect to a displacement of the displacement unit in the pressing direction.

9. A method for sticking a threadlike adhesive, comprising sticking the threadlike adhesive to the object using the threadlike adhesive sticking apparatus according to claim 1.

10. The threadlike adhesive sticking apparatus according to claim 3, wherein the slit is formed along a path in which the threadlike adhesive is disposed on the release liner.

11. The threadlike adhesive sticking apparatus according to claim 2, wherein the threadlike adhesive is traverse-wound around a reel over a width of a predetermined length via the release liner, and the release liner is a sheet having a size having at least the predetermined width and a length of at least an outer circumference of the reel.

12. The threadlike adhesive sticking apparatus according to claim 3, wherein the threadlike adhesive is traverse-wound around a reel over a width of a predetermined length via the release liner, and the release liner is a sheet having a size having at least the predetermined width and a length of at least an outer circumference of the reel.

13. The threadlike adhesive sticking apparatus according to claim 4, wherein the threadlike adhesive is traverse-wound around a reel over a width of a predetermined length via the release liner, and the release liner is a sheet having a size having at least the predetermined width and a length of at least an outer circumference of the reel.

14. The threadlike adhesive sticking apparatus according to claim 10, wherein the threadlike adhesive is traverse-wound around a reel over a width of a predetermined length via the release liner, and the release liner is a sheet having a size having at least the predetermined width and a length of at least an outer circumference of the reel.

15. The threadlike adhesive sticking apparatus according to claim 2, further comprising:
a nozzle comprising an inner wall surface defining a cylindrical internal space and comprising a tip end having a tip end opening at one end of the inner wall surface, the tip end opening allowing the internal space to communicate with the outside,
wherein the pressing unit is configured to press the threadlike adhesive allowed to pass through the internal space and is led out to the outside from the tip end opening, against the object, and
portions of a peripheral portion surrounding the tip end opening at the tip end function as the pressing unit.

16. The threadlike adhesive sticking apparatus according to claim 3, further comprising:
a nozzle comprising an inner wall surface defining a cylindrical internal space and comprising a tip end having a tip end opening at one end of the inner wall surface, the tip end opening allowing the internal space to communicate with the outside,
wherein the pressing unit is configured to press the threadlike adhesive allowed to pass through the internal space and is led out to the outside from the tip end opening, against the object, and
portions of a peripheral portion surrounding the tip end opening at the tip end function as the pressing unit.

17. The threadlike adhesive sticking apparatus according to claim 4, further comprising:
a nozzle comprising an inner wall surface defining a cylindrical internal space and comprising a tip end having a tip end opening at one end of the inner wall surface, the tip end opening allowing the internal space to communicate with the outside,
wherein the pressing unit is configured to press the threadlike adhesive allowed to pass through the internal space and is led out to the outside from the tip end opening, against the object, and
portions of a peripheral portion surrounding the tip end opening at the tip end function as the pressing unit.

18. The threadlike adhesive sticking apparatus according to claim 5, further comprising:
a nozzle comprising an inner wall surface defining a cylindrical internal space and comprising a tip end having a tip end opening at one end of the inner wall surface, the tip end opening allowing the internal space to communicate with the outside,
wherein the pressing unit is configured to press the threadlike adhesive allowed to pass through the internal space and is led out to the outside from the tip end opening, against the object, and
portions of a peripheral portion surrounding the tip end opening at the tip end function as the pressing unit.

19. The threadlike adhesive sticking apparatus according to claim 2, further comprising:
an assist mechanism configured to apply an external force in a feeding direction to the threadlike adhesive wound together with the release liner,
wherein the pressing unit is configured to press the fed out threadlike adhesive debonded from the release liner against the object.

20. The threadlike adhesive sticking apparatus according to claim 3, further comprising:
an assist mechanism configured to apply an external force in a feeding direction to the threadlike adhesive wound together with the release liner,
wherein the pressing unit is configured to press the fed out threadlike adhesive debonded from the release liner against the object.
